(19) United States
(12) Patent Application Publication
(10) Pub. No.: US 2009/0208228 A1
(43) Pub. Date: Aug. 20, 2009

(54) IMAGE FORMING APPARATUS AND IMAGE FORMING METHOD

(75) Inventors: Hidetoshi Asasaka, Sagamihara-shi (JP); Yoichi Takaragi, Yokohama-shi (JP); Shinichi Fukada, Kawasaki-shi (JP); Toshikazu Sekizawa, Fujisawa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/372,330

(22) Filed: Feb. 17, 2009

(30) Foreign Application Priority Data
Feb. 20, 2008 (JP) 2008-039269

(51) Int. Cl. G03G 15/00

(52) U.S. Cl. 399/15

(57) ABSTRACT

An image forming apparatus and an image forming method are provided, which can reduce time and effort needed by consistency examination between a printed code data and a paper fingerprint data. In the present invention, paper fingerprint information before starting of the printing of the paper for output on which the document to be guaranteed in the originality authenticity is to be printed is acquired. When printing the document to be guaranteed in the originality authenticity, a code image data generated based on the paper fingerprint data of the paper for output on which the document is to be printed and the document mentioned above, are printed on the paper for output. Subsequently, the paper fingerprint data before starting of the printing and the paper fingerprint data after finishing of the printing are collated, then, it is judged whether the paper for output mentioned above is a paper-fingerprint deformation paper.

### BACKGROUND OF THE INVENTION

1. Field of the Invention

The present invention relates to an image forming apparatus and an image forming method which can deal with paper fingerprint information.

2. Description of the Related Art

A so-called paper fingerprint is known as one of anti-counterfeit technologies of documents, which is a technology of reading a fiber of a paper and preventing a counterfeit by using the fiber pattern as an ID of the paper from viewpoints of low cost etc. is known.

The pamphlet WO 2005/071939 disclose a technology which encodes a read paper fingerprint data into a two-dimensional code image or a bar code image, etc., prints the encoded data on the paper surface, and verifies the original document authenticity based on this code data, in order to guarantee the original document authenticity.

It is generally supposed that this paper fingerprint dose not vary even in the case of that heat, bending or an aged deterioration is generated.

However, there is no open information with respect to an investigation, which shows what kind of relation there is between a heat resistance of the paper fingerprint and raw materials which compose the paper. Even if properties for every paper type are investigated and the resistance for the heat is able to be acquired, it is impossible to investigate all the paper types which are circulating in a market.

In such a prerequisite, in the original document authenticity guarantee system which prints the code data having the paper fingerprint encoded on the paper surface, such as represented by the technology disclosed in the pamphlet WO 2005/071939, the paper fingerprint data (paper fingerprint information) is acquired from a blank paper before printing and the paper after finishing of the printing of the document to generate the code data. And the code data is printed on the paper surface.

However, in printing processes at the time of printing the code data, if the heat is applied on the paper for fixing of ink or toner, etc., the paper may perform thermal expansion and contraction with the heat. If such thermal expansion and contraction happens, the paper fingerprint may have changed. Moreover, in the above-mentioned printing processes, contaminations may be generated in the area where the paper fingerprint has been taken, because of splashing of the ink and toner or after having been carried through a paper-carrying roller, etc. When there are such contaminations, the paper fiber pattern which composes the paper may change by absorbing color materials such as ink, etc., for example. And, even if the paper fiber pattern itself is unchanged, the paper fingerprint could change with the existence of the above-mentioned contaminations.

When the paper fingerprint has changed because of the above phenomena in the printing process, the consistency between the paper fingerprint and the code data printed on the paper surface for collating is lost. Therefore, in the case of starting the operation of the original document authenticity guarantee system based on the paper fingerprint, it is required for securing the reliability to issue the document after examining that the consistency of the code data and the paper fingerprint is maintained, at the time point of issuing the document guaranteed in the originality authenticity.

Next, while the points having been described above are arranged, the operation processes required by the document issuance which guarantees the original document authenticity using the paper fingerprint will be described.

Process step 1 (acquisition process): the acquisition and encoding of the paper fingerprint.

Process step 2 (printing process): printing of the code data.

Process step 3 (examination process): the consistency examination between the printed code data and the paper fingerprint after printing.

Thus, these three process steps are needed even when classified largely. In the above-mentioned examination process step, it is judged that no variation has been generated in the paper fingerprint and the document is valid in the case of that the above-mentioned code data and the paper fingerprint are in agreement as the result of collating of the paper fingerprint with the printed code data. On the other hand, in the case of that the above-mentioned code data and the paper fingerprint are not in agreement as the result of the above-mentioned collating, it is judged that the document is invalid. In the examination process step, since it is judged whether the paper fingerprint before starting of the printing and the paper fingerprint after finishing of the printing are in agreement by examining the consistency between the printed code data and the paper fingerprint after printing, the cause with which the document is judged to be invalid as mentioned above is considered to be the variation of the paper fingerprint above-mentioned. In this description, the paper and the document of which the paper fingerprint have changed on account of the thermal expansion and contraction and contaminations, etc. in this way, are made to be called “paper fingerprint deformation paper” and “paper fingerprint deformation document”, respectively.

In the case of securities or the like which are issued documents having the consecutive numbers given thereto, for example, if the paper fingerprint deformation document is detected in the examination process step, the user extracts this paper fingerprint deformation document out of the documents for which the consecutive numbers have been given. Therefore, in the case of the paper fingerprint deformation document being extracted, the document of the missing number must be issued and a very much troublesome work comes out.

Thus, in the case of that the paper fingerprint has changed (deformation) on account of the contaminations on the paper fingerprint detection area or on account of the expansion and contraction because of the heat at the time of printing in which the heat is given at the time of the fixing, etc., for example, it is necessary to replace the paper and to perform the process steps 1 to 3 again with regard to the paper fingerprint deformation document in order to collateralize the security. That is, in the case of that the paper fingerprint has changed on account of a reason which is difficult to anticipate, the user needs to remove the paper fingerprint deformation document, and the original having been printed on the paper fingerprint deformation paper needs to be reprinted in order to maintain the security. As for such reprinting, in the case of printing a plurality of documents, for example, the user extracts the paper fingerprint deformation paper from the plurality of documents, conventionally as mentioned above, and the image having been formed in the paper fingerprint deformation paper are printed again according to the process steps 1 to 2. And when it is judged that the consistency is maintained at the process step 3, the user restores the re-printed documents to the position mentioned above from which the document has been extracted among the plurality of documents. Thus, conventionally, in the case of the paper fingerprint deformation paper being detected, time and effort have been cost in order to provide the document in which the security has been collateralized as a result.

Moreover, if the paper fingerprint deformation document is included in the printed documents, the document will have been judged to be invalid in the check process of the original document authenticity by the following collation between the code data and the paper fingerprint even if the document is the original. Therefore, in order to avoid the unexpected decision of being invalid, the above-mentioned examination process step (process step 3) needs to be performed after printing, and is work which costs time and effort extremely. That is, the above-mentioned examination process step is necessary also in order to guarantee that the document having the code image data printed thereon is what has the high security. However, conventionally, after the completion of process step 2, the user performed required setting thereof to perform process step 3. Therefore, the examination of the consistency between the data printed and the paper fingerprint data costs time and effort extremely as mentioned above.

Meanwhile, as the contaminations on the above-mentioned paper fingerprint area, paper contaminations at the time of moving through the apparatus, chafing remains at the time of moving through the apparatus and contaminations at the time of printing, etc. are considered, for example.

Further, since the work for the paper replacing is also needed in the case of that the apparatus which processes these three process steps differs, a considerable man-hour will be required in the document issuance.

### SUMMARY OF THE INVENTION

The present invention provides an image forming apparatus and an image forming method which can reduce time and effort needed by consistency examination between a printed code data and a paper fingerprint data, even in the case of variations having arisen in the paper fingerprint on account of reason which is difficult to be anticipated (for example, contaminations at the time of printing, thermal expansion and contraction at the time of printing, etc.).

The present invention comprises:

a component for printing a code image data generated based on a paper fingerprint data of a paper for output on which a document is to be printed and the document on the paper for output, when printing the document to be guaranteed in the originality authenticity;

a component for acquiring the paper fingerprint data before starting of the printing which is the paper fingerprint data of the paper for output before starting of the printing;

a component for acquiring the paper fingerprint data after finishing of the printing which is the paper fingerprint data of the paper for output after finishing of the printing;

a component for collating, after the finishing of the printing, the paper fingerprint data before starting of the printing and the paper fingerprint data after finishing of the printing; and

a component for judging, based on the collated result, whether the paper for output being the paper with paper fingerprint thereof deformed.

And the present invention comprises the steps of:

printing a code image data generated based on a paper fingerprint data of a paper for output on which a document is to be printed and the document on the paper for output, when printing the document to be guaranteed in the originality authenticity;

collating, after finishing of the printing, the paper fingerprint data before starting of the printing which is the paper fingerprint data of the paper for output before starting of the printing and the paper fingerprint data after finishing of the printing which is the paper fingerprint data of the paper for output after finishing of the printing; and

judging whether the paper for output is the paper with the paper fingerprint thereof deformed, based on the collated result,

where the paper fingerprint data before starting of the printing and the paper fingerprint data after finishing of the printing are acquired before the step for collating.

The present invention can provide the image forming apparatus and the image forming method, which can reduce time and effort needed by the consistency examination between the printed code data and the paper fingerprint data, even in the case of variations having arisen in the paper fingerprint. In addition, the present invention provides the image forming apparatus which can process in succession three processes of operation at the time of the document issuance in the original document authenticity guarantee based on the paper fingerprint (The three processes of operation refer to “acquisition and encoding of the paper fingerprint”, “printing of the code data”, and “the consistency examination of the issued document”.).

As the result, an effect to reduce paper-replacing work between apparatuses and man-hour concerning the re-printing of the invalid document discovered by the examination after printing which have been generated heretofore is obtained.

Further features of the present invention will become apparent from the following description of exemplary embodiments (with reference to the attached drawings).

### BRIEF DESCRIPTION OF THE DRAWINGS

FIG. 1 illustrates an entire configuration of an image forming system according to an embodiment of the present invention;

FIG. 2 shows an external view of an I/O device of an image forming apparatus according to an embodiment of the present invention;

FIG. 3 illustrates an entire configuration of the image forming apparatus according to an embodiment of the present invention;

FIG. 4 illustrates conceptually tile data according to an embodiment of the present invention;

FIG. 5 shows a block diagram of a scanner image processing part according to an embodiment of the present invention;

FIG. 6 shows a block diagram of a printer image-processing part according to an embodiment of the present invention;

FIG. 7 shows an explanatory view of a copy screen displayed in an operation part according to an embodiment of the present invention;

FIG. 8 shows a flowchart of a paper fingerprint information acquisition process according to an embodiment of the present invention;

FIG. 9 shows a flowchart of a paper fingerprint information collation processing according to an embodiment of the present invention;

FIG. 10 shows a sectional view of the image forming apparatus according to an embodiment of the present invention;

FIG. 11 shows an overview of a printer driver according to an embodiment of the present invention;

FIG. 12 shows a flowchart at the time of paper fingerprint information register according to an embodiment of the present invention;

FIG. 13 shows a flowchart of code information examination processing according to an embodiment of the present invention;

FIG. 14 shows a flowchart at the time of paper fingerprint information collating according to an embodiment of the present invention;

FIG. 15 shows a flowchart at the time of paper fingerprint paper register according to an embodiment of the present invention; and

FIG. 16 shows a block diagram of an image forming apparatus for POD according to an embodiment of the present invention.

### DESCRIPTION OF THE EMBODIMENTS

Hereafter, preferred embodiments according to the present invention are described in detail with reference to figures. However, constituents described in the embodiments are exemplifications to the last, which do not intend to limit the scope of this invention. In the figures described in the following, an element having the same function will be labeled with the same numeral and the duplicate explanation will be omitted.

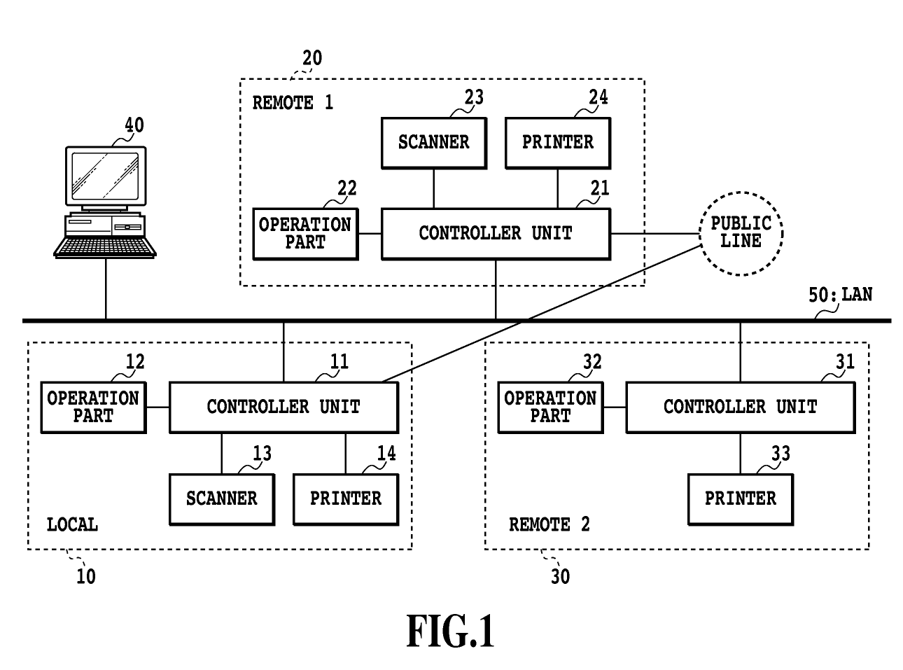

### A First Embodiment

<A Printing System (FIG. 1)>

Subsequently, the embodiment according to the present invention is described in detail with reference to figures. FIG. 1 shows a block diagram illustrating a configuration of a printing system according to the embodiment of the present invention. In this system, host computer 40 and three image forming apparatus (10, 20, 30) are connected to LAN 50. However, in the printing system in the present invention, the numbers of connections are not limited to these numbers of connections. Although LAN is applied as a connection method in the embodiment, the connection method is not limited to this. For example, any networks such as WAN (public circuit), and serial transmission systems such as USB and parallel transmission systems such as Centronics and SCSI, etc. are applicable.

Host computer (hereafter referred to as PC) 40 has a function of a personal computer. This PC 40 can transmit and receive a file or an E-mail using FTP or SMB protocol via LAN 50 or WAN. And PC 40 can give a print command through a printer driver for image forming apparatus 10, 20, and 30.

Image forming apparatus 10 and 20 are apparatuses which have the same configuration, and are MFT (Multi Function Printer), for example. Image forming apparatus 30 is an image forming apparatus having only print function, and does not have a scanner part which image forming apparatus 10 and 20 have. In the following, in order to simplify the description, paying attention to image forming apparatus 10 among the image forming apparatuses 10 and 20, the configuration is described in detail.

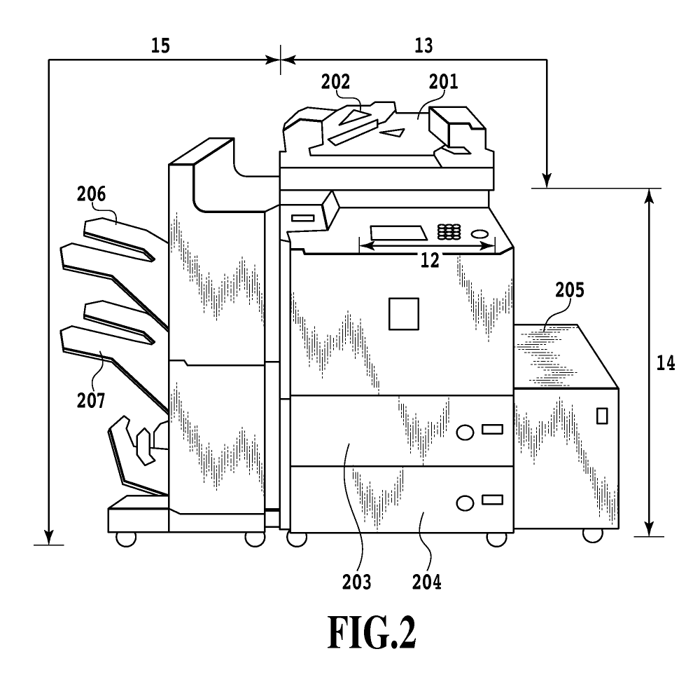

Image forming apparatus 10 includes a scanner part 13 which is an image input device, and a printer part 14 which is an image output device. Image forming apparatus 10 also includes a controller (Controller Unit) 11 which manages operation control of overall image forming apparatus 10 and an operation part 12 which is a user interface (UI).

<Image Forming Apparatus 10 (FIG. 2)>

An external appearance of image forming apparatus 10 is shown in FIG. 2. Scanner part 13 has a plurality of CCDs. When the sensitivity of each of the CCDs differs, respectively, even if the density of each pixel over an original is uniform, pixels would have been recognized as having the different density. Therefore, in the scanner part, an exposure scanning of a white reference plate (uniformly white plate) is performed first, and then the amount of the reflected light obtained by performing the exposure scanning is converted into an electrical signal which is output to controller 11.

In addition, as mentioned later, shading correction part 500 in controller 11 recognizes the distinction in the sensitivity of each CCD based on the electrical signal acquired from each CCD. And the value of the electrical signal acquired by scanning the image on the original is corrected using the distinction in this recognized sensitivity. Further, when receiving the information on gain adjustment from CPU 301 in controller 11 mentioned later, shading correction part 500 will perform gain adjustment corresponding to this information. The gain adjustment is used in order to control how the value of the electrical signal acquired by performing the exposure scanning of the original is allocated to the luminance signal value of 0 to 255. This gain adjustment has been made to be able to convert the value of the electrical signal acquired by performing the exposure scanning of the original into a high luminance signal value or into a low luminance signal value. Subsequently, the configuration which scans the image on this original will be described.

By inputting into CCD the reflected light obtained by performing the exposure scanning of the image on the original, scanner part 13 converts the information of the image into the electrical signal. Furthermore, scanner part 13 converts the electrical signal into the luminance signal including each color of R, G, and B, and outputs the luminance signal as the image data to controller 11.

On the other hand, the original is set at tray 202 of original feeder 201. When the user instructs starting of reading through operation part 12, the original reading instruction is given to scanner part 13 from controller 11. When receiving the instruction, scanner part 13 will feed every one sheet of the original documents respectively from tray 202 of original feeder 201 to perform read operation of the original. Here, a reading method of the original may be the method of scanning the original by placing the original on a glass surface which is not shown and by making the exposure part move, in stead of an automatic feed system by original feeder 201.

Printer part 14 is an image formation device which forms on the paper the image data received from controller 11. In the embodiment according to the present invention, an image formation method is an electrophotographic system which uses a photo conductor drum or a photo conductor belt. However, the present invention is not limited to this. For example, an inkjet method which injects ink from a very small nozzle array to print on the paper is also applicable. Printer part 14 is provided with a plurality of paper cassettes 203 and 205 which make a different paper size or a different paper direction selectable, and with cassette 204 for paper fingerprint deformation papers which accommodates the paper fingerprint deformation papers which are the papers on which the printing has failed. The papers after printing are ejected by paper ejection trays 206 and 207 in finisher 15.

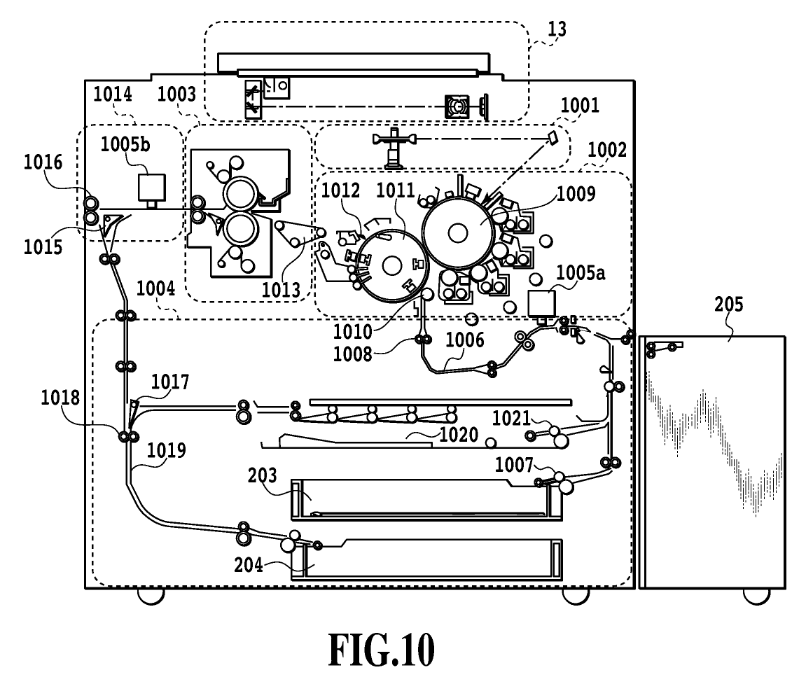

A sectional view of printer part 14 is illustrated in FIG. 10. Printer part 14 is provided with laser exposure part 1001, imaging part 1002, fixing part 1003, feeding/carrying part 1004, and controller 11 for controlling them. Laser exposure part 1001 makes a light ray such as a laser beam modulated corresponding to above-mentioned image data enter as incident light into the rotating polygon mirror (polygon mirror) which rotates with a constant angular velocity, and irradiates photoconductor drum 1009 with the reflective scan light therefrom.

Imaging part 1002 drives and rotates photoconductor drum 1009, makes the drum 1009 be charged by an electrostatic charging device, makes a latent image formed on photoconductor drum 1009 by the above-mentioned laser exposure part 1001 be developed using toner, and transfers the toner image on a sheet (paper). In such case, a series of electrophotographic processes to the effect that a little toner remaining on photoconductor drum 1009 without being transferred is retrieved are performed for the image to be formed. In such case, while the sheet winds around the prescribed position on the transferring belt and rotates four times, each development unit (developing station) having the toner of magenta (M), cyanogen (C), yellow (Y), and black (K) performs, by turns, execution of the above-mentioned electro-photography processes one by one repeatedly. After 4 rotations, the sheet which has the full color toner image of four colors transferred thereon leaves transcription drum 1011, and is carried to fixing part 1003.

Fixing part 1003 consists of the combination of the roller and the belt etc., incorporates the heat source of a halogen heater etc., and dissolves and fixes, with the heat and the pressure, the toner on the sheet on which the toner image has been transferred by the above-mentioned imaging part 1002. When the sheet passes this imaging part 1002 and fixing part 1003, the possibility that contaminations on the image and the expansion and contraction of the paper because of the heat are generated is high.

Feeding/carrying part 1004 has one or more sheet storage sheds represented by a sheet cassette and a paper deck, dissociates one sheet out of a plurality of sheets accommodated in the sheet storage sheds corresponding to the instruction from controller 11, and carries the sheet to imaging part 1002 and fixing part 1003. The sheet is wound around transcription drum 1011 of imaging part 1002, and is carried to fixing part 1003 after rotating four times. While rotating four times, the toner image of each YMCK color mentioned above is transferred on the sheet. In the case of performing image formation on both sides of the sheet, the sheet which has passed fixing part 1003 is controlled so as to pass again through the carrying path which carries the sheet to imaging part 1002.

The paper fingerprint of the fed paper before printing is read by paper fingerprint reading sensor 1005a provided on paper carrying path 1006. The paper fingerprint of the paper after printing which has passed imaging part 1002 and fixing part 1003 is read by paper fingerprint reading sensor 1005b provided on the paper carrying pass of paper ejection part 1014. These paper fingerprint reading sensors 1005a and 1005b read asperities and overlaps of random fibers on the fed paper, converts the information on the image composed by the asperities and overlaps of the read fibers into an electrical signal, and furthermore converts the electrical signal into the luminance signal comprising each color of R, G, and B, which is output to controller 11 as the image data. The information generated in this way will be the paper fingerprint information (paper fingerprint data).

<Description of the Feeding/carrying Part>

Feeding/carrying part 1004 includes paper cassettes 203 and 205, cassette 204 for paper fingerprint deformation papers, feed roller 1007 and resist roller 1008.

Sheets (paper for output) having various sizes and materials are held in paper cassettes 203 and 205. In each paper cassette, feed roller 1007 is provided respectively, and every sheet is fed one by one. Specifically, the sheets loaded are let out one by one by the pickup roller, and the sheets are sent out to a carrying guide one by one while double feeding is prevented by the separation roller provided opposed to feed roller 1007. Here, a driving force which is made to rotate the separation roller in a reverse direction against the carrying direction is input via the torque limiter which is not shown. When only one sheet is entering into a nip part formed in the space against feed roller 1007, the separation roller rotates in the carrying direction following the sheet. On the other hand, in the case of that the double feed arises, the double-fed sheets are returned by being rotated in the reverse direction against the carrying direction, and only one sheet of the topmost part is sent out.

The sent-out sheet is guided in between carrying guides, and is carried to resist roller 1008 by a plurality of carrying rollers. At this time, resist roller 1008 is stopped, and the tip of the sheet collides against the nip part formed by the pair of resist rollers 1008, and the sheet forms a loop, and the skew is corrected. After that, in accordance with the timing of the toner image formed on photoconductor drum 1009 in the image formation part, resist roller 1008 starts rotation and carries the sheet.

The sheet sent by resist roller 1008 is electro-statically adsorbed to the surface of transcription drum 1011 by absorption roller 1010. On the other hand, on photoconductor drum 1009, the toner image has been formed according to the predetermined process. The sheet adsorbed by transcription drum 1011 rotates according to the rotation of transcription drum 1011, and high voltage is applied thereto by the transcription electrostatic charging device in the position opposed to photoconductor drum 1009, and the toner image on photoconductor drum 1009 is electro-statically transcribed on the surface of the sheet. When forming the color image, the sheet on transcription drum 1011 goes around further, and the toner image for each of four colors of CMYK is transcribed repeatedly.

The sheet for which the transferring process is completed is separated from transcription drum 1011 by separating claw 1012, and is carried by carrying-before-fixing unit 1013 to fixing part 1003. Carrying-before-fixing unit 1013 is provided with a suction fan and a rubber belt suspended with a plurality of rollers. The sheet is sucked by the suction fan to the rubber-belt side, and is carried with the rubber belt rotated by the driving source which is not illustrated.

In fixing part 1003, the toner image fixes on the sheet with being pressurized and heated, and is sent to paper ejection part 1014.

Paper ejection part 1014 is provided with paper ejection flapper 1015 and paper ejecting roller 1016. Paper ejection flapper 1015 is composed swingably around a swing axis, and prescribes the carrying direction of the sheet. When paper ejection flapper 1015 is swinging in the clockwise direction in the figure, the sheet is carried straightly, and is ejected by paper ejecting roller 1016 outside the apparatus. On the other hand, when the image is formed in both sides of the sheet, paper ejection flapper 1015 swings in the counter clockwise direction in the figure, and the sheet is made to be changed in the direction downward and is sent into a both side carrying part.

The both side carrying part is provided with inversion flapper 1017, inversion roller 1018, inversion guide 1019, and both side tray 1020. Inversion flapper 1017 is composed swingably around swing axis, and prescribes the carrying direction of the sheet. First, inversion flapper 1017 swings in the counter clockwise direction in the figure, and the sheet is sent into inversion guide 1019 by inversion roller 1018. In the state where the back end of the sheet has been sandwiched by inversion roller 1018, inversion roller 1018 stops once, and succeedingly, inversion flapper 1017 swings in the clockwise direction in the figure. Further, inversion roller 1018 rotates in the reverse direction, and the sheet is carried with performing switchback and is led to both side tray 1020 in the state where the back end and the tip have changed their places.

In both side tray 1020, the sheet is once loaded, and after that, the sheet is again sent into resist roller 1008 by paper-refeeding roller 1021. At this time, the sheet has been sent thereinto while the surface opposite to the case of the transferring process of the first surface side is made to be the side opposed to photoconductor drum 1009. And the image of the second surface side is formed in the same way as the process mentioned above, and the image is formed in both sides of the sheet, and the sheet is ejected outside the apparatus through the fixing process.

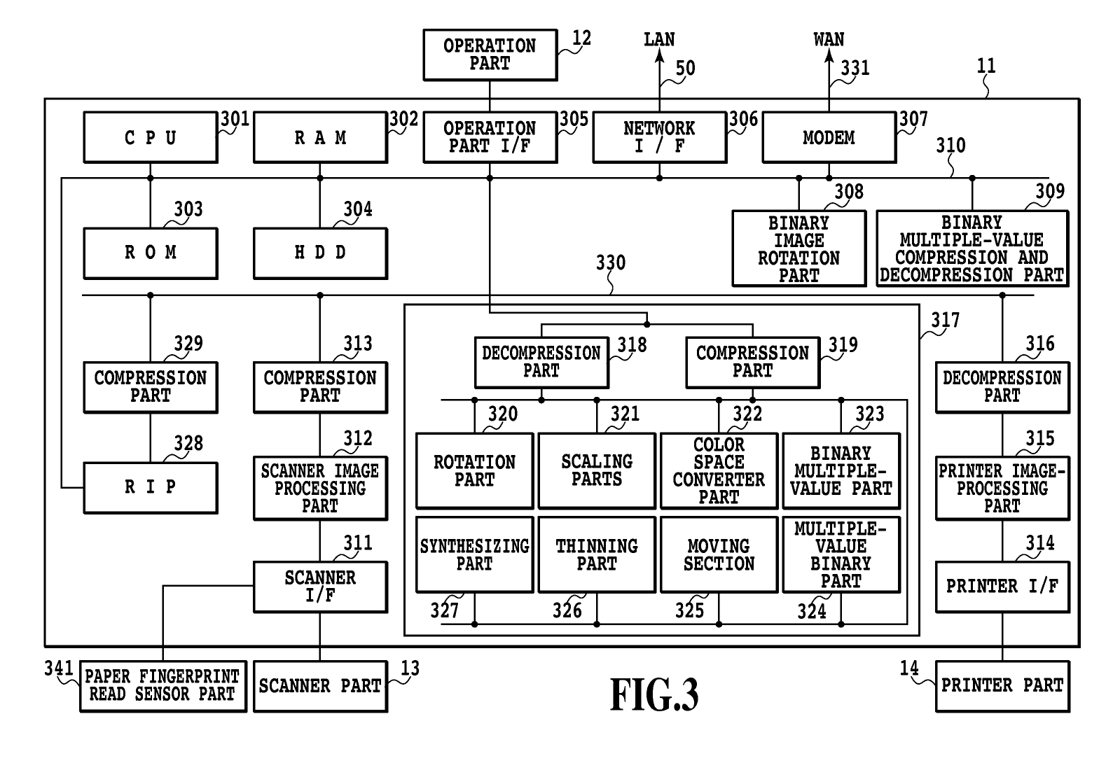

In the case of that paper fingerprint deformation paper is generated in the printing process, paper ejection flapper 1015 swings in the counter clockwise direction in the figure, and the sheet is made to be changed in the direction thereof downward and the sheet is sent into the both side carrying part to be accommodated in cassette 204 for paper fingerprint deformation papers located ahead of the paper carrying pass following inversion guide 1019. In this case, the sheet passes inversion guide 1019 while inversion roller 1018 is in the positive rotation.

<Detailed Description of Controller 11 (FIG. 3)>

FIG. 3 shows a block diagram for illustrating a configuration of controller 11 of the image forming apparatus more in detail. Controller 11 is electrically connected with paper fingerprint reading sensor portion 341, scanner part 13, and printer part 14, and on the other hand, is connected with PC 40, an external apparatus, etc. via LAN 50 and WAN 331. Thereby, the input/output of the image data or device information is made to be possible.

CPU 301 integrally controls accesses with the various devices connected thereto, based on control programs stored in ROM 303 and the like as well as integrally controls also various processes performed inside the controller. RAM 302 is a system work memory for CPU 301 to operate and is also the memory for performing temporary storage of the image data. This RAM 302 can include SRAM which maintains stored contents also after power off and DRAM where the stored contents will be eliminated after power off. Boot programs of the apparatus, etc. are stored in ROM 303. HDD 304 is a hard disk drive and is able to store system software and the image data. In the embodiment according to the present invention, CPU 301 performs various processing operations such as calculation, control, and discrimination in accordance with the control programs such as processes according to the embodiment of the present invention stored in ROM 303 and HDD 304.

Operation part I/F 305 is an interface part for connecting system bus 310 with operation part 12. This operation part I/F 305 receives the image data for displaying on operation part 12 from system bus 310, outputs to operation part 12 (displays in operation part 12) and outputs the information input from operation part 12 to system bus 310.

Network I/F 306 is connected with LAN 50 and system bus 310, and outputs or inputs the information. Modem 307 is connected with WAN 331 and system bus 310, and outputs or inputs the information. Binary image rotation part 308 converts the direction of the image data before transmission. Binary image compression and decompression part 309 converts the resolution of the image data before transmission into the predetermined resolution or the resolution in accordance with the other side capability. In the case of the compression and decompression, methods such as JBIG, MMR, MR, and MH, are used. Image bus 330 is a transmission path for exchanging the image data, and comprises PCI bus or IEEE 1394.

Scanner image processing part 312 performs correcting, converting, and editing for the image data received from paper fingerprint reading sensor part 341 and scanner part 13 via scanner I/F 311. Scanner image processing part 312 judges whether the received image data is a color document or a monochrome document, and a text document or a photographic document, etc. Then, the judged result is made to accompany the image data. Such accompanying information is called property data thereof. The detail of the process performed in this scanner image processing part 312 is described later.

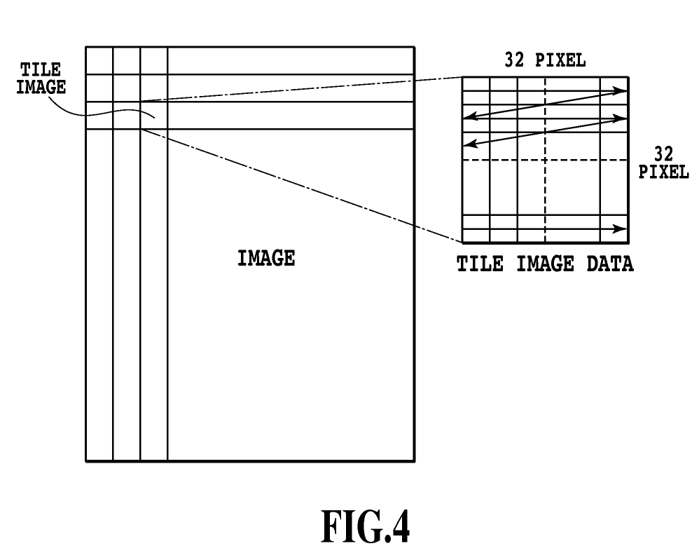

Compression part 313 receives the image data and divides this image data into a block unit of 32 pixels×32 pixels. Here, the image data of 32 pixels×32 pixels is called a tile data. FIG. 4 illustrates this tile data conceptually. In an original (paper medium before reading), an area corresponding to this tile data is called a tile image. The average brightness information in the block of 32 pixels×32 pixels and the coordinate position of the tile image on the original are added to the tile data as the header information thereof. Furthermore, compression part 313 compresses the image data which includes a plurality of the tile data. After decompressing the image data which includes a plurality of the tile data, decompression part 316 raster-develops the image data to be sent to printer image-processing part 315.

Printer image-processing part 315 receives the image data sent from decompression part 316 performs image processing of the image data while referring to the property data accompanied by this image data. The image data after image processing is output to printer part 14 via printer I/F 314. The detail of the process performed in this printer image-processing part 315 is described later.

Image conversion part 317 performs predetermined conversion process to the image data. This processing part is provided with processing parts as shown in the following.

Decompression part 318 decompresses the received image data. Compression part 319 compresses the received image data. Rotation part 320 rotates the received image data. Scaling part 321 performs resolution conversion processing (for example, from 600 dpi to 200 dpi) for the received image data. Color space converter 322 converts the color space of the received image data. This color space converter 322 can perform the heretofore known background color removing process using a matrix or a table, can perform the heretofore known LOG conversion processing (RGB to CMY), and can perform the heretofore known output color compensation processing (CMY to CMYK). Binary multiple-value converter 323 converts the received image data of 2 gray scales into the image data of 256 gray scales. Conversely, multiple-value binary converter 324 converts the received image data of 256 gray scales into the image data of 2 gray scales by a method such as error diffusion processing.

Synthesizing part 327 synthesizes two received image data to generate the image data of one sheet. In addition, when two image data are synthesized, applied are a method for making an average of the luminance values which the two pixels for being synthesized have, to be a synthetic luminance value, and a method for making the luminance value of the pixel of the brighter one in the luminance level to be the luminance value of the pixel after synthesis. It is possible to apply the method for utilizing the luminance value of the darker pixel for the pixel after synthesizing. Furthermore, the method for determining the luminance value after synthesis, etc. by OR operation, AND operation and exclusive OR operation, etc. of the two pixels to be synthesized can be applied. Each of these synthesizing methods is a well-known method. Thinning part 326 performs the resolution conversion by thinning out pixels of the received image data, and generates the image data such as ½, ¼, and ⅛. Moving section 325 provides a blank space portion to the received image data or deletes the blank space portion.

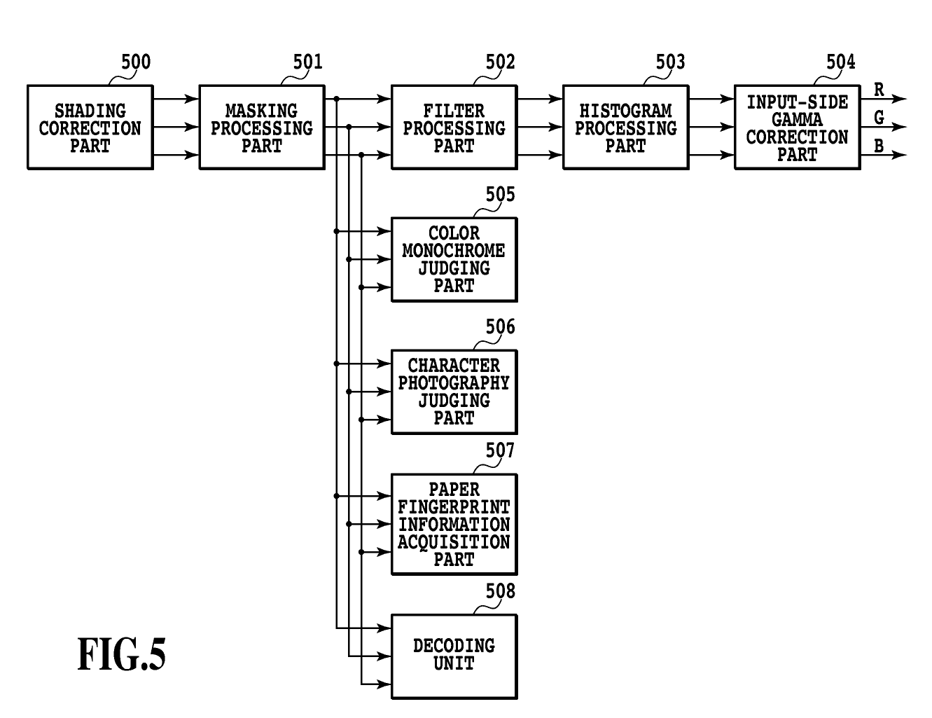

RIP part 328 receives the intermediate data generated by compression part 329 based on the PDL coded data transmitted from PC40, etc., and generates bit map data (multiple value).

<Detailed Description of Scanner Image Processing Part 312 (FIG. 5)>

An internal configuration of scanner image processing part 312 is shown in FIG. 5.

Scanner image processing part 312 receives the image data which comprises the luminance signal of each RGB 8 bits. Shading correction part 500 performs shading correction on the luminance signal. The shading correction is a process for preventing the false recognition of the brightness of the original because of dispersion in the sensibility of CCD, as mentioned above. Further, this shading correction part 500 is able to perform gain adjustment according to the instructions from CPU 301, as mentioned above.

Subsequently, this luminance signal is converted into the standard luminance signal which does not depend on the filter color of CCD by masking processing part 501.

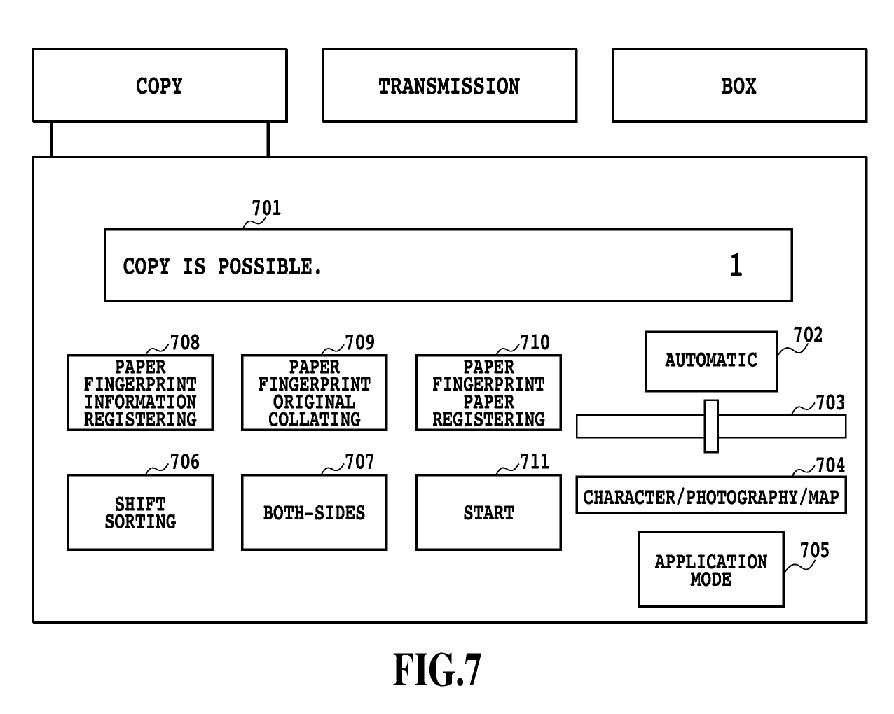

Filter processing part 502 corrects the spatial frequency of the received image data arbitrarily. This processing part performs data processing for the received image data using the 7×7 matrix, for example. In a copying machine or a MFP, a character mode, a photographing mode, and a character/photographing mode can be selected as the copy mode by the depression operation of tab 704 in FIG. 7. Here, in the case of that the character mode is selected by the user, filter processing part 502 applies the filter for characters to the overall image data. Moreover, in the case of photographing mode being selected, filter processing part 502 applies the filter for photography to the overall image data. Moreover, in the case of that the character/photographing mode is selected, filter processing part 502 switches the filter adaptively for every pixel corresponding to the after-mentioned character/photograph decision signal (part of the property data). That is, it is decided whether to apply the filter for photography or to apply the filter for characters for every pixel. In addition, in the filter for the photography, coefficients with which the smoothing is performed only for a high frequency component are set up. This is because of making the rough surface of the image not be visible. Moreover, in the filter for characters, coefficients with which a little stronger edge enhancement is performed are set up. This is because of producing the sharpness of the characters.

Histogram generating part 503 samples the luminance data of each pixel of the received image data. Describing in more detail, histogram generating part 503 samples the luminance data in the rectangular area surrounded by the start point and the end point designated in the main scanning direction and the subs-canning direction respectively, in a constant pitch in the main scanning direction and the subs-canning direction. Then, histogram data is generated based on the sampling result. The generated histogram data is used in order to estimate the background level when performing the background color removing process. Input-side gamma correction part 504 converts the luminance data into what has a nonlinear characteristic using a table, etc.

Color/monochrome judging part 505 judges whether each pixel of the received image data is chromatic or achromatic, and makes the judged result accompany the image data as a color monochrome judging signal (as a part of the property data).

Character photography judging part 506 judges whether each pixel which composes the image data is the pixel composing a character, or the pixel composing a halftone dot, or the pixel composing the character within the halftone dot, or the pixel composing a solid image based on the pixel value of each pixel and the pixel value of the peripheral pixel of each pixel. The pixel not applicable to any is the pixel which composes the white area. Then, the judged result is made to accompany the image data as the character/photograph decision signal (as a part of the property data).

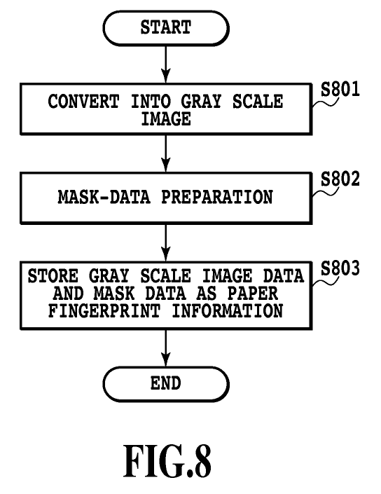

Paper fingerprint information acquisition section 507 acquires the image data (paper fiber image) of the predetermined areas (at least one or more areas) from masking processing part 501 among the image data of RGB input into masking processing part 501 from shading correction part 500. Hereafter, the details of the paper fingerprint information acquisition process which paper fingerprint information acquisition section 507 performs will be described in detail by referring to FIG. 8.

FIG. 8 shows a flowchart illustrating the paper fingerprint information acquisition process which this paper fingerprint information acquisition section 507 performs. Here, paper fingerprint information acquisition section 507 is controlled by CPU 301 of controller 11 as mentioned above.

At step 801, paper fingerprint information acquisition section 507 converts the image data (paper fiber image) extracted as above-mentioned into the image data of the grayscale.

At step 802, paper fingerprint information acquisition section 507 creates a mask data for collating by removing what can cause an erroneous decision such as printed or handwritten characters, in the image data converted into the image data of the grayscale in step 801. The mask data is binary data of “0” or “1”. In the image data of the grayscale, the value of the mask data is set as “1” about the pixel whose luminance signal value is beyond a first threshold value (that is, bright). And the value of the mask data is set as “0” about the pixel whose luminance signal value is less than the first threshold value (that is, dark). The above process is performed for each pixel included in the image data of the grayscale.

At step 803, paper fingerprint information acquisition section 507 acquires, as the paper fingerprint information, the two data of the image data converted into the grayscale in step 801 and the mask data created in step 802.

Paper fingerprint information acquisition section 507 sends the paper fingerprint information on the above-mentioned predetermined region (paper fingerprint data) to RAM 302 using a data bus which is not shown.

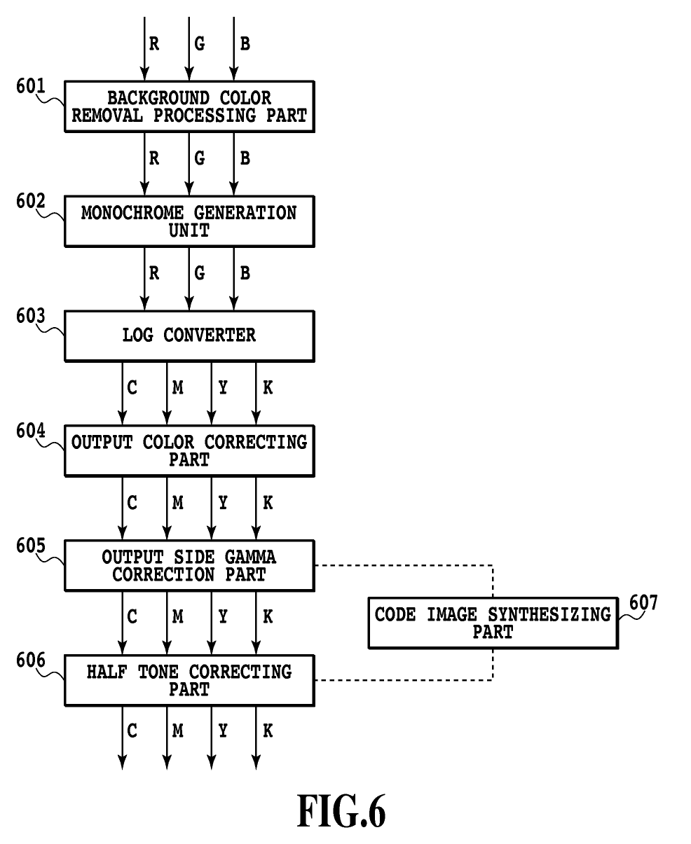

In the case of that a code image data exists in the image data output from masking processing part 501, decoding unit 508 detects the existence. And the detected code image data (code data) are decoded, and the information is taken out.

<Detailed Description of Printer Image-processing Part 315 (FIG. 6)>

FIG. 6 shows a flow of the processing performed in printer image processing 315. The data input into the output picture processing part is categorized largely into the data of RGB system treating the output data from the input image processing part such as the copying operation, and into the data of CMYK system treating the output data from the RIP part such as the network printing operation.

In the case of the former, the data is input into background color removing process part 601, and in the case of the latter, the data is input into output side gamma correction part 605.

Background color removing process part 601 subtracts (removes) the background color of the image data using the histogram generated in scanner image processing part 312. Monochrome generation unit 602 converts the color data into the monochrome data. Log converter 603 performs luminance density conversion. This Log converter 603 converts the image data input with RGB into the image data of CMY, for example. Output color correcting part 604 performs output color correction. For example, output color correcting part 604 converts the image data input with CMY into the image data of CMYK using the table and the matrix. Output side gamma correction part 605 corrects so that the signal value input into this output side gamma correction part 605 may be proportional to the reflection density value after the copy output. Code image synthesizing part 607 synthesizes the image data (original) corrected in output side gamma correction part 605 and the code image data (code data) generated by the “paper fingerprint information encoding process” mentioned later. Half tone correcting part 606 performs half tone process according to the gradation number of the outputting printer part. For example, binarization and 32 value-ization, etc. are performed for the received high gradation image data.

In each processing part in scanner image processing part 312 or printer image-processing part 315, it is also possible to make the received image data output without performing respective process. Thus, in the following, it will be expressed as “making it pass through the processing part” that the data are passed without being processed in a certain processing part.

<Paper Fingerprint Information Encoding Process>

CPU 301 is made to be able to control to read out the paper fingerprint information (paper fingerprint data) of the predetermined region which has been sent to RAM 302 from paper fingerprint information acquisition section 507, and to perform the encoding process of the read paper fingerprint information, and to generate the code image data (code data) thereby.

In the description of the present invention, “code image” means the image in which information can be embedded, such as a two-dimensional code image and a bar code image, or an electronic watermark which comprises invisible dots.

Further, CPU 301 is able to control the generated code image data to be transmitted to code image synthesizing part 607 in printer image-processing part 315 using the not shown data bus.

The above-mentioned control (forming and controlling of the code image, and the transmission control) is performed by CPU 301 executing the program stored in RAM 302.

<Paper Carrying Control Pre-processing>

In the embodiment according to the present invention, the image forming device acquires, before the image formation (before printing) on the paper for output, the paper fingerprint information on the predetermined area which will be the paper fingerprint acquisition area of this paper for output, at the time of the output of the document guaranteed in the originality authenticity. That is, as for the paper for output, the image forming apparatus acquires the paper fingerprint information (it is also called the paper fingerprint information before starting of the printing) of the paper fingerprint acquisition area of this paper for output, before printing the code image data acquired by encoding the paper fingerprint of this paper for output and the document data which will be the object of the original document authenticity guarantee. Such paper fingerprint information before starting of the printing is acquired by paper fingerprint reading sensor 1005a. That is, paper fingerprint reading sensor 1005a reads the image data (paper fiber image) of the paper fingerprint acquisition area of the paper for output before starting of the printing, and paper fingerprint information acquisition part 507 extracts the paper fingerprint information before starting of the printing from this read image data.

Following describes the configuration for generating the paper fingerprint information which will become the base of the code image data to be printed on the paper for output at the time of forming the image mentioned above based on the image data acquired by paper fingerprint reading sensor 1005a before starting of the printing. That is, in the following description, based on the image data acquired before the above-mentioned starting of the printing, the paper fingerprint information which will become the base of the code image data to be printed on the above-mentioned paper for output, and the paper fingerprint information before starting of the printing are acquired.

In the embodiment according to the present invention, when the paper for output during being carried passes over paper carrying pass 1006, paper fingerprint reading sensor 1005a performs paper fingerprint reading processing, and reads the image data. This read image data is sent to paper fingerprint information acquisition section 507. This paper fingerprint information acquisition part 507 extracts, as the paper fingerprint information, the following two data of the image data converted into the grayscale and the mask data to send to RAM 302 by the process shown in FIG. 8. Thus, the paper fingerprint information stored in RAM 302 will become the paper fingerprint information which will be the base of the code image data to be printed on the above-mentioned paper for output, and at the same time, will become the paper fingerprint information before starting of the printing used for collating with the paper fingerprint information after finishing of the printing mentioned later.

The paper fingerprint encoding process using this paper fingerprint information, a code image synthesizing process, a half tone compensation process, and the process that transmits the synthesized image data to printer part 14 must be performed within the following period. That is, these processing must be performed from the time point when the paper has passed paper fingerprint reading sensor 1005a and when the paper fingerprint reading processing has been performed, to the time point when the printing is performed in imaging part 1002. That is, after the paper has passed paper fingerprint reading sensor 1005a, in the case of that the process by which the synthesized image data is sent to printer part 14 is later than the process by which the paper is sent to imaging part 1002, the process for stopping the paper carrying will be needed.

After the reading of the paper fingerprint, controller 11 issues the instruction of stopping the paper carrying to the not shown paper carrying control part. The paper carrying control part receives the instruction of stopping the paper carrying, makes paper carrying pass 1006 stop, and stops the paper carrying.

After that, the paper fingerprint encoding process, the code image synthesizing process and the half tone compensation process are completed, the synthesized image data is sent to printer part 14 via printer I/F 314, and the printing on the paper becomes possible, and then, controller 11 issues a paper carrying restarting instruction to the paper carrying control part. The paper carrying control part receives the paper carrying restarting instruction, and resumes the paper carrying.

In the embodiment according to the present invention, the important thing is to acquire the paper fingerprint of the paper fingerprint acquisition area in this paper for output before printing the code image data and the document data which is the object of the above-mentioned original document authenticity guarantee on the paper for output. Therefore, the paper fingerprint information which becomes the base of the code image data, as mentioned above, may be the paper fingerprint information extracted at the time of the acquisition of the paper fingerprint information before starting of the printing, or may have been acquired in advance as mentioned later.

While the detail about the case where the paper fingerprint information is acquired in advance is described later, the paper for output to be the target is made to be scanned by scanner part 13, and the paper fingerprint information is made to be acquired by paper fingerprint information acquisition part 507 based on the image data obtained with this scan and the acquired paper fingerprint information may be made to be stored in RAM 302. And the paper fingerprint information acquired with other image readers may be made to be acquired via LAN 50 or WAN 331.

In the case of acquiring in advance the paper fingerprint information which will become the base of the code image data, the paper for output corresponding to the acquired paper fingerprint information is set on the paper cassette, and the code image data corresponding to the above-mentioned paper fingerprint information acquired in advance is printed on the set paper for output. For example, the user may select, via operation part 12, the paper fingerprint information for the paper for output which has been set as mentioned above, and the paper fingerprint information which will be the base of code image data may be just extracted from RAM 302 corresponding to this selection, and may be just encoded to generate the synthesized image data.

Thus, in the embodiment according to the present invention, at the time of printing the above-mentioned paper for output, the image forming apparatus may just hold the paper fingerprint information which will become the base of the code image data.

<Paper Carrying Control Post-processing>

In the embodiment according to the present invention, as the same as the paper carrying control pre-processing, the image forming device acquires the paper fingerprint information in the predetermined area of this paper for output which is the paper fingerprint acquisition area after forming the image (after printing) on the paper for output, at the time of outputting the document guaranteed in the originality authenticity. That is, after printing, on the paper for output, the code image data and the document data which will become the object of the original document authenticity guarantee, the image forming apparatus acquires the paper fingerprint information (this is also called the paper fingerprint information after finishing of the printing) of the paper fingerprint acquisition area of this paper for output. Such paper fingerprint information after finishing of the printing is acquired by paper fingerprint reading sensor 1005b. That is, paper fingerprint reading sensor 1005b reads the image data (paper fiber image) from the paper fingerprint acquisition area of the paper for output after finishing of the printing, and paper fingerprint information acquisition part 507 extracts the paper fingerprint information after finishing of the printing from this read image data.

In the embodiment according to the present invention, when the paper for output after the printing passes through paper ejection part 1014 after the process in imaging part 1002 and fixing part 1003, paper fingerprint reading sensor 1005b performs paper fingerprint reading processing and reads the image data. This read image data is sent to paper fingerprint information acquisition part 507. This paper fingerprint information acquisition part 507 extracts the following two data of the image data converted into the grayscale and the mask data as the paper fingerprint information, and sends them to RAM 302 as paper fingerprint information for examination by the process shown in FIG. 8.

In “paper fingerprint information collation processing” mentioned later, the image forming device collates the paper fingerprint information before starting of the printing acquired in the paper carrying control pre-processing and the paper fingerprint information after finishing of the printing acquired in the paper carrying control post-processing, and then, in the case of “valid”, ejects the paper outside the apparatus. On the other hand, in the case of “invalid”, the image forming apparatus judges that the paper fingerprint deformation paper has been generated in the printing process, and accommodates this paper in the cassette 204 for paper fingerprint deformation papers. And simultaneously, the image forming apparatus performs re-printing of the synthesized image data printed on the paper fingerprint deformation paper.

The paper fingerprint information collation processing using this paper fingerprint information must be performed from the time point of the paper for output having passed paper fingerprint reading sensor 1005b and of the paper fingerprint reading processing having been performed to the time point the paper tip entering into paper ejection flapper 1015. That is, after the paper for output has passed paper fingerprint reading sensor 1005b, the processing which stops the paper carrying will be needed in the case of that paper fingerprint information collation processing is later than the paper for output being sent to paper flapper 1015.

After reading the paper fingerprint, controller 11 issues the instruction of stopping carrying paper to the paper carrying control part which is not shown. The paper carrying control part stops the paper carrying in paper ejection part 1014 in response to the instruction of stopping carrying the paper.

Then, after the paper fingerprint information collation processing is completed and the collated result comes out, controller 11 issues the restarting instruction for the paper carrying to the paper carrying control part. The paper carrying control part receives the paper carrying restarting instruction, and resumes the paper carrying.

<Paper Fingerprint Information Collation Processing>

In the paper fingerprint information collation processing, CPU 301 can read out and collate the paper fingerprint information and the paper fingerprint information for examination which have been sent to RAM 302 from paper fingerprint information acquisition part 507. Here, the paper fingerprint information means the paper fingerprint information acquired from the paper before starting of the printing in a paper fingerprint information register designation process, or the paper fingerprint information decoded from the code image in the original paper in the paper fingerprint original collation processing. And the paper fingerprint information for examination means the paper fingerprint information acquired from the paper after finishing of the printing in the paper fingerprint information register designation process, or the paper fingerprint information acquired from the original paper in paper fingerprint original collation processing.

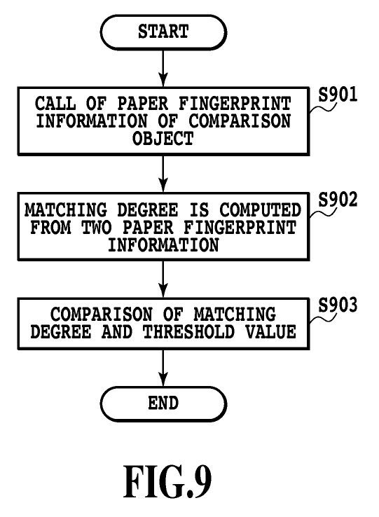

FIG. 9 shows a flowchart illustrating this paper fingerprint information collation processing. CPU 301 integrally controls for each step of the flowchart.

In step 901, the paper fingerprint information which will be a comparison target is taken out from RAM 302. As a case where the paper fingerprint information collation processing is carried out, there are the case of the paper fingerprint information registration processing and the case of the paper fingerprint original collation processing, and in the case of the paper fingerprint information registration processing, the paper fingerprint information before starting of the printing is taken out from RAM 302. In the case of the paper fingerprint original collation processing, the paper fingerprint information included in the code image data is taken out from RAM 302.

At step 902, in order to collate the paper fingerprint information (paper fingerprint information for examination) sent from paper fingerprint information acquisition part 507 and the paper fingerprint information taken out in step 901, the matching degree of the two paper fingerprint information is computed using a formula (1). Here, it is assumed that one paper fingerprint information is what is obtained by shifting the other paper fingerprint information. In the function shown in the formula (1), while every pixel is made to be shifted, an error image (E) of the two paper fingerprint information is calculated at the point where the value obtained from the function of the formula (1) becomes the minimum, that is, at the point where the difference of the two paper fingerprint information become the smallest.

In the case of that the paper fingerprint information collation processing is the collation processing performed from paper fingerprint information registration processing, the paper fingerprint information sent from the above-mentioned paper fingerprint acquisition part 507 will be made to be the paper fingerprint information for examination after finishing of the printing. On the other hand, the paper fingerprint information acquired in step 901 mentioned above will be made to be the paper fingerprint information before starting of the printing.

E=(α₁f₁²\hat{x}α₂)−2(α₁f₁\hat{x}α₂f₂)+(α₁\hat{x}α₂f₂²) formula (1)

In the formula (1), α₁ indicates the mask data in the paper fingerprint information taken out at step 901, and f₁ indicates the gray scale image data within the paper fingerprint information taken out at step 901. In addition, α₂ indicates the mask data within the paper fingerprint information which has been sent from paper fingerprint information acquisition part 507 at step 902, and f₂ indicates the gray scale image data within the paper fingerprint information which has been sent from paper fingerprint information acquisition part 507 at step 902.

In order to digitize the result of the paper fingerprint information collating from the error image, processes described in the following are performed. Each luminance signal value of the pixel of the error image which has been obtained with the function of the formula (1) is made to be inverted to be a negative value. Further, an average of each negative value is calculated, and a difference value between the average and the each negative value is calculated. Subsequently, a standard deviation is made to be calculated from the each calculated difference value, and the each negative value is made to be divided by the standard deviation to calculate a quotient. Finally, the maximum of the calculated quotients is made to be the matching degree of the two paper fingerprint information. As the result, the matching degree of this paper fingerprint information is expressed with zero or more values, and the degree of coincidence of the two above-mentioned paper fingerprint information is higher as this matching degree is large.

At step 903, the comparison with the matching degree of the two paper fingerprint information calculated in step 902 and the predetermined threshold value is performed, and “Valid” or “invalid” is determined.

The description of controller 11 is above-mentioned.

<Description of an Operation Screen>

Operation part 12 of image forming apparatus 10 is described.

FIG. 7 shows an initial screen of operation part 12 in image forming apparatus 10. Display area 701 indicates whether image forming apparatus 10 is in the state where copy is possible, and also indicates the set-up number of copies. Reading mode tab 702 is a tab for selecting the reading mode of the original. When this tab is depressed, three kinds of selection menus of Color/Black/Automatic (ACS) are displayed in pop up. In the case of “Color” being selected, color copying is performed, and in the case of “Black” being selected, monochrome copying is performed. And in the case of ACS being selected, the copy mode is determined by the monochrome/color decision signal mentioned above.

Density tab 703 is a tab for controlling the shade of the image, and sliding the tab to right and left makes the shade of the image of objects to be printed adjustable. Original selection tab 704 is a tab for selecting the type of the original, and when this tab is depressed, three kinds of selection menus of Character Mode, Photography Mode, and Character/Photographing Mode, are displayed in pop up. Application mode tab 705 is a tab used in the case of setting up various copy modes which cannot be set up by the copy standard screen. Finishing tab 706 is a tab for performing setting in connection with various finishing.

Both-side setting tab 707 is a tab for performing setting with respect to both-side read-in and both-side printing. Paper fingerprint information register tab 708 is a tab for selecting the paper fingerprint information registration processing. The paper fingerprint information registration processing is described later. Paper fingerprint original collating tab 709 is a tab for selecting the paper fingerprint original collation processing. This paper fingerprint original collation processing is described later. Paper fingerprint paper register tab 710 is a tab for selecting the paper fingerprint paper registration processing used for a paper fingerprint information register. The paper fingerprint paper registration processing is described later. Start tab 711 is a start button for starting the process of copying, etc.

<A Setting Screen of the Printer Driver>

The print job which performs the paper fingerprint information register is described.

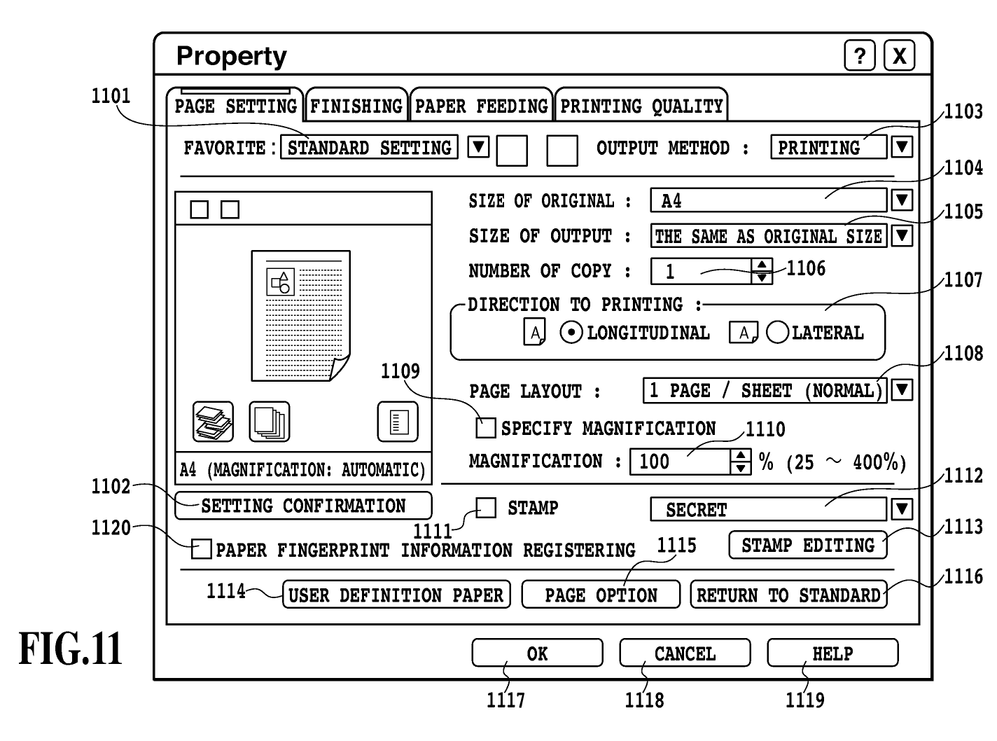

FIG. 11 illustrates an embodiment of properties setting screen configuration relevant to a page setup process of the printer driver. This printer driver is installed in host computer 40 and used when the network printing mentioned above is performed.

In “Favorites” pull-down list box 1101, an optimal page setup is selected out of page setup modes determined in advance. A favorite selection item can be added or edited with two buttons located in the right. And by depressing “Setting Confirmation” button 1102, contents having been set up in the properties setting screen can be displayed in a list, and the contents having been set up in the properties setting screen are reflected to the page image currently displayed above.

In “Output Method” pull-down list box 1103, by what kind of method the output to printing devices such as MFT are performed is specified. As selectable methods, output methods such as Normal Printing, Secure Printing, Storing at Hard Disk of Print Device, and Performing Editing and Preview with Print Device can be specified. In “Size of Original ” pull-down list box 1104 and “Size of Output Paper” pull-down list box 1105, the original size which will be the printing object and the output paper size of the print device are selected. In “Number of Copy” spin box 1106, number of copies to be printed is input, and in “Direction of Printing” radio button 1107, the direction of the paper for output of the print device like “longitudinal” and “lateral” is selected.

In “Page Layout” pull-down list box 1108, N-up printing (printing in which two or more pages on one printing surface are arranged) is specified. In the case of check box 1109 “Specify Magnification” being made into a selective state, the magnification of enlargement/reduction is input into “Magnification” spin box 1110 by percentage. In the case of “Stamp” check box 1111 being made into a selective state, a type out of stamps determined in advance is selected in pull-down list box 1112. The type of stamp can be added or edited by performing the depression of the “stamp editing” button 1113.

By depressing “User Definition Paper” button 1114, the user definition paper can be defined, and by depressing “Page Option” button 1115, still more detailed page options can be set up. These settings can be returned to the default by depressing “Return to Standard” button 1116. When an operator finishes setting of the properties setting screen of the printer driver, these printing properties can be reflected to actual printing by depressing “OK” button 1117. In the case of stopping setting the properties setting screen, what is necessary is just to perform the depression of the “Cancellation” button 1118. “Help” button 1119 displays a help screen of the properties setting screen.

“Paper fingerprint information register” check box 1120 is for selecting the paper fingerprint information registration processing. The paper fingerprint information registration processing is mentioned later.

<Operation at the Time of “Paper Fingerprint Information Register” Designation Being Selected>

Described is the paper fingerprint information registration processing in the case of that paper fingerprint information register tab 708 of FIG. 7 and “Paper fingerprint information register” check box 1120 illustrated in FIG. 11 are selected by the user, and that a scan job or the print job is performed.

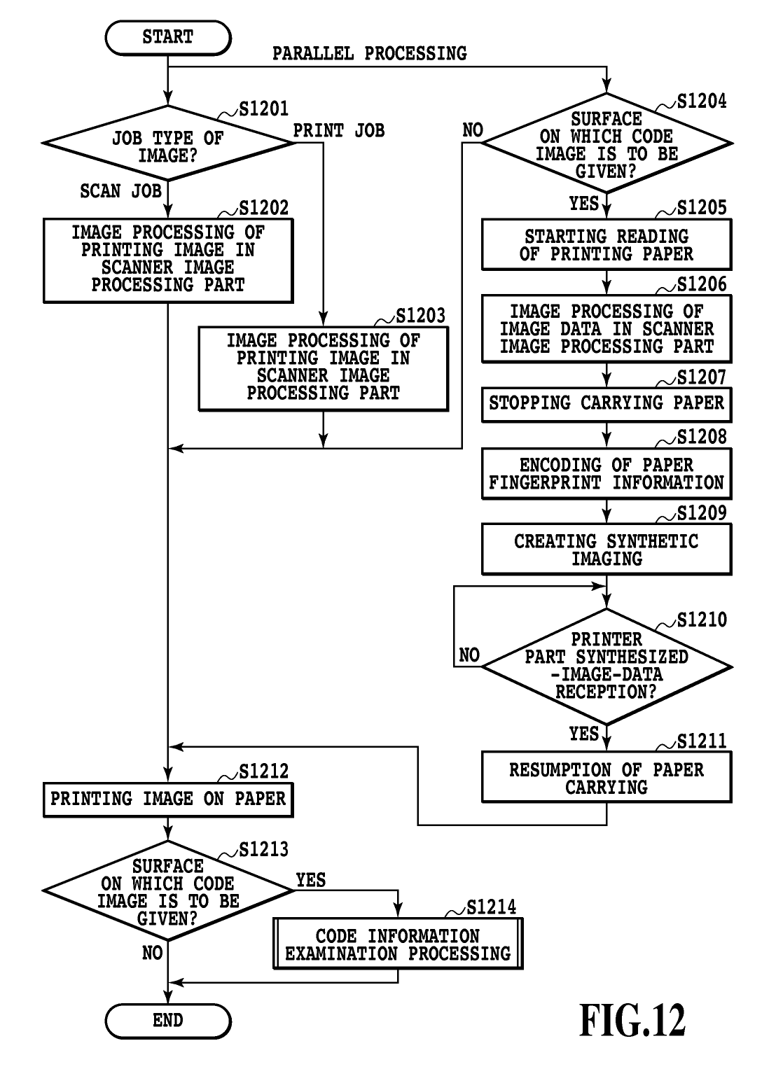

FIG. 12 shows a flowchart of the paper fingerprint information registration processing according to the embodiment of the present invention.

In step 1201, CPU 301 detects the type of the job having been performed. That is, CPU 301 analyzes the job to detect the type of the job, and controls to perform step 1202 in the case of the scan job and to perform step 1203 in the case of the printing job. Step 1204 is started in parallel at the same time step 1201 is performed.

At step 1202, CPU 301 controls to send the original read by scanner part 13 to scanner image processing part 312 via scanner I/F 311 as the image data. Scanner image processing part 312 performs the process illustrated in FIG. 5 for this image data, and generates the property data as well as the image data. And Scanner image processing part 312 makes this property data accompany the image data. Subsequently, the image data is controlled to be sent to compression part 313, and is divided into the block unit of 32 pixels×32 pixels to generate the tile data. Furthermore, compression part 313 compresses the image data which comprises a plurality of the tile data.

CPU 301 controls to send the image data compressed by compression part 313 to RAM 302 to be stored therein. This image data is sent to image conversion part 317 and image processing is performed as necessary, and is sent again to RAM 302 to be stored therein after that. CPU 301 sends the image data stored in RAM 302 to decompression part 316 to be decompressed therein. Furthermore, decompression part 316 performs raster development of the image data which comprises a plurality of the tile data after decompression. The image data after the raster development is sent to printer image-processing part 315, and image data editing corresponding to the property data accompanied to the image data is performed. This process is turned to be the process illustrated in FIG. 6 and the data processed therein is sent to printer part 14 via printer I/F 314 after the half tone process is performed in accordance with the gray scale of the printer part output by half tone correcting part 606.

At step 1203, CPU 301 stores packet data transferred from PC 40 etc. on the network via LAN 50, once in RAM 302 via network I/F 306. CPU 301 analyzes this stored packet data to take out PDL coded data, and stores the PDL coded data in HDD 304. Next, CPU 301 takes out the PDL data from HDD 304, and performs rendering in RIP part 328 to generate the property data as well as the image data. And CPU 301 makes this property data accompany the image data. Subsequently, the image data is controlled to be sent to compression part 329 and is divided into the block unit of 32 pixels×32 pixels for the tile data to be generated. Furthermore, compression part 329 compresses the image data which comprises a plurality of the tile data.

CPU 301 controls to send the image data compressed by compression part 313 to RAM 302 to be stored therein. This image data is sent to image conversion part 317 and image processing is performed as necessary, and is sent again to RAM 302 to be stored therein after that. CPU 301 sends the image data stored in RAM 302 to decompression part 316 to be decompressed therein. Furthermore, decompression part 316 performs raster development of the image data which comprises a plurality of the tile data after decompression. The image data after the raster development is sent to printer image-processing part 315, and image data editing corresponding to the property data accompanied to the image data is performed. This process is turned to be the process illustrated in FIG. 6 and the data processed therein is sent to printer part 14 via printer I/F 314 after the half tone process is performed in accordance with the gray scale of the printer part output by half tone correcting part 606.

At step 1204, CPU 301 judges whether the page corresponding to the job currently processed at step 1201 is the surface on which the code information (code image data) is to be given. Based on a configuration of printer part 14 illustrated in FIG. 10 according to the embodiment of the present invention, paper fingerprint reading sensor 1005b is made to be in the disposition (printing surface in FIG. 10) where only reading of the surface of one direction is possible for the paper carried by paper ejection part 1014. Therefore, in the case of performing both-side printing in the process of the job which comprises two or more pages, it is desirable for the code information to be given on a second side. As the reason, in the case of that the code information is given to a first side (surface printed first in the both-side printing processes) in the both-side printing, the reading of the paper fingerprint of the first side is impossible when a second side (surface printed thereon in the second in the both-side printing processes) is printed and ejected. This is because the consistency confirmation of the code information using the paper fiber image (paper fingerprint information) immediately before the paper ejection which is the point of the present invention cannot be performed for the first side. (In the case of that the both-side printing is performed with the code information printed on the first side, the code information of the first side will not be able to be guaranteed.)

Thus, in the embodiment of the present invention, it is preferred to perform collation processing (code information examination processing mentioned later) of the paper fingerprint information before starting of the printing and the paper fingerprint information after finishing of the printing, when the paper is actually ejected. Therefore, in the case of both-side printing, the second side will become the surface on which the code image data will be printed, and the code information examination processing is performed after finishing of the printing of the second side. On the other hand, in the case of single side printing, since the paper is ejected after printing of the first side, the first side will become the surface on which the code image data will be printed, and the code information examination processing is performed after finishing of the printing of the first side.

Therefore, in this step, CPU 301 analyzes the job and judges whether the job is single side printing or both-side printing. In the case of the single side printing, CPU 301 judges that the printing surface of the paper which is currently being carried is the surface for the code image data to be given thereon, and progresses to step 1205. On the other hand, in the case of the both-side printing, CPU 301 judges whether the surface of the paper which is currently being carried is a first side or a second side. As for this judgment whether the first side or the second side, CPU 301 judges that the surface is the first side as the above-mentioned in the case of that the paper which is currently being carried is carried from paper cassette 203 and that the process is a first printing in the both-side printing, for example. And in the case of that the paper which is currently being carried is carried from paper cassette 1020 and that the process is a second printing in the both-side printing, CPU 301 may be made to judge that the surface is the second side as the above-mentioned.

In both-side printing, in the case of that the surface of the paper which is currently being carried is the first side, CPU 301 judges that the printing surface of the paper which is currently being carried is not the surface for the code image data to be given thereon and progresses to step 1212. In the case of the surface of the paper which is currently being carried is the second side, CPU 301 judges that the printing surface of the paper which is currently being carried is the surface for the code data to be given thereon and progresses to step 1205.

An image forming apparatus based on a printing method which does not have fixing part 1003, since the variation of the paper fiber on account of the heat does not come out in the ink jet printer, etc., for example, can print the code information on the first side and the second side even based on the disposition of the paper fingerprint reading sensor which can read only the surface of one direction.

At step 1205, CPU 301 controls to read the paper fiber image (image data which will become the base for acquiring the paper fingerprint information) by paper fingerprint reading sensor 1005a when the paper for output passes paper carrying pass 1006. And, CPU 301 controls to send the image data (paper fiber image) to scanner image processing part 312 via scanner I/F 311.

At step 1206, scanner image processing part 312 sets up, in shading correction part 500, a gain adjustment value smaller than the commonly-used gain adjustment value at the time of reading by scan part 13. And scanner image processing part 312 outputs each luminance signal value acquired by applying the above small gain adjustment value to the image data acquired at step 1205, to paper fingerprint information acquisition part 507. Based on the output data, paper fingerprint information acquisition part 507 acquires the paper fingerprint information from the image data (paper fiber image) mentioned above. And this acquired paper fingerprint information is sent to RAM 302 using a not shown data bus. The paper fingerprint information acquired at step 1206 will become the paper fingerprint information which becomes the base of the code image data generated at step 1208, and at the same time, will become the paper fingerprint information before starting of the printing.

At step 1207, CPU 301 stops the paper carrying as described in <Paper carrying control pre-processing>.

At step 1208, CPU 301 generates the code image data by encoding the paper fingerprint information acquired at step 1206, and controls to transmit this generated code image data to code image synthesizing part 607 in printer image-processing part 315.

At step 1209, CPU 301 performs control for synthesizing the code image data generated at step 1208 and the print image data processed in parallel. In accuracy, code image synthesizing part 607 synthesizes the print image data output from output side gamma correction part 605 and the code image data generated at step 1208. And half tone correcting part 606 performs a half tone processing for this synthesized image data obtained by the synthesis according to the gradation number of the output printer part. The synthesized image data after the half tone processing is sent to printer part 14 via printer I/F 314.

At step 1210, controller 11 judges whether printer part 14 has received the synthesized image data generated at step 1209.

At step 1211, when printer part 14 has received the synthesized image data, that is, when printer part 14 has changed into the state where the printing is possible, controller 11 issues the paper carrying restarting instruction to the paper carrying control part as described in <Paper carrying control pre-processing>. The paper carrying control part receives the paper carrying restarting instruction, and resumes the paper carrying.

At step 1212, printer part 14 forms the image of the print image data on the paper for output. In the case of the surface on which the code information (code image data) is to be given, this print image data will become the image data with which the code image has been synthesized at step 1209.

At step 1213, CPU 301 judges whether the page under process is the surface for the code information to be given thereon like step 1204. The case where the page is judged not being the above-mentioned surface for the code information to be given thereon is the case where the first side in the both-side printing is printed. Therefore, in this case, after finishing once the process illustrated in FIG. 12, the process will progress to step 1201 again in order to perform the process of the second side.

In step 1213, in the case of that it is judged that the surface is the above-mentioned surface for the code information to be given thereon, CPU 301 progresses to step 1214 and performs the code information examination processing.

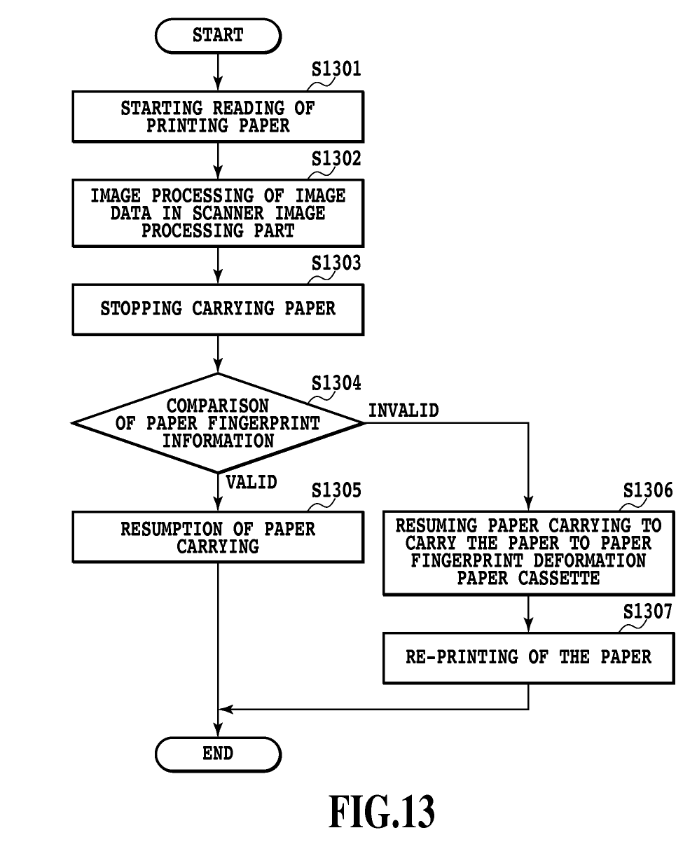

The code information examination processing in step 1214 is described in the following. FIG. 13 shows a flowchart of the code information examination processing according to the embodiment of the present invention.

At step 1301, when the print-process-completion paper having passed the process in imaging part 1002 and fixing part 1003 is carried to paper ejection part 1014 and passes there, CPU 301 controls to acquire the paper fiber image of the paper read by paper fingerprint reading sensor 1005b. And CPU 301 controls to send this acquired image data (paper fiber image) to scanner image processing part 312 via scanner I/F 311.

At step 1302, scanner image processing part 312 sets up the gain adjustment value smaller than the commonly used gain adjustment value in shading correction part 500, and outputs each luminance signal value having been acquired by applying the small gain adjustment value mentioned above to the image data acquired at step 1301, to paper fingerprint information acquisition part 507. Paper fingerprint information acquisition part 507 acquires paper fingerprint information based on the output data, and sends this acquired paper fingerprint information to RAM 302 as the paper fingerprint information for examination by using the not shown data bus. The paper fingerprint information acquired at step 1302 will become the paper fingerprint information after finishing of the printing.

At step 1303, CPU 301 stops the paper carrying as described in <Paper carrying control post-processing>.

At step 1304, CPU 301 collates, in <Paper fingerprint information comparison processing>, the paper fingerprint information before starting of the printing stored in RAM 302 at above-mentioned step 1206 and the paper fingerprint information for examination (paper fingerprint information after finishing of the printing) stored at step 1302. And in the case of “valid”, CPU 301 judges that there is no deformation in the paper fingerprint which becomes the base of the paper fingerprint information after finishing of the printing, and progresses to step 1305. On the other hand, in the case of “invalid”, CPU 301 judges that the deformation arose in the paper fingerprint which becomes the base of the paper fingerprint information after finishing of the printing, and progresses to step 1306.

At step 1305, in the case of that the code information on the print-process-completion paper is judged to be valid, controller 11 issues the paper carrying restarting instruction to the paper carrying control part as described in <Paper carrying control post-processing>. The paper carrying control part receives the paper carrying restarting instruction, resumes the paper carrying, and ejects the paper outside the apparatus.

At step 1306, in the case of that the code information on the print-process-completion paper is judged to be invalid, controller 11 issues the paper carrying restarting instruction to the paper carrying control part as described in <Paper carrying control post-processing>. The paper carrying control part receives the paper carrying restarting instruction, resumes the paper carrying and the paper is accommodated in cassette 204 for paper fingerprint deformation papers.

At step 1307, controller 11 starts the re-printing process of this paper under process.

Thus, in the code information examination processing, the image forming apparatus can judge whether the paper for output which is going to be ejected is the paper with the paper fingerprint thereof deformed, based on the collated result of the paper fingerprint information before starting of the printing and the paper fingerprint information after finishing of the printing.

<Operation at the Time of “Paper Fingerprint Original Collating” Designation Being Selected>

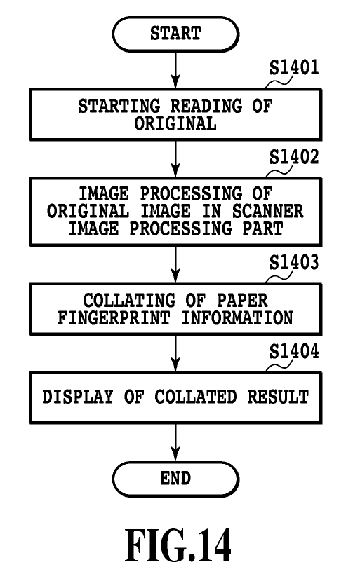

Subsequently, the operation at the time of paper fingerprint original collating tab 709 illustrated in FIG. 7 being depressed by the user will be described using the flowchart of FIG. 14.

At step 1401, in the paper fingerprint original collation processing, CPU 301 controls to send the original read by scanner part 13 to scanner image processing part 312 via scanner I/F 311 as the image data.

At step 1402, scanner image processing part 312 performs the process illustrated in FIG. 5 for this image data and generates the property data as well as a new image data after setting the commonly used gain adjustment value in shading correction part 500, and makes this property data accompany the image data.

Further, at this step 1402, paper fingerprint information acquisition part 507 in scanner image processing part 312 sets up the gain adjustment value smaller than the commonly used gain adjustment value in shading correction part 500 in order to acquire the paper fingerprint information. And by the small gain adjustment value mentioned above being applied to the image data, each acquired luminance signal value is output to paper fingerprint information acquisition part 507. Paper fingerprint information acquisition part 507 acquires the paper fingerprint information based on the output data, and sends this acquired paper fingerprint information to RAM 302, using the not shown data bus as the paper fingerprint information for examination.

Further, at this step 1402, decoding unit 508 in scanner image processing part 312 decodes this code image to acquire the paper fingerprint information in the code in the case of that the code image exists, and sends the acquired paper fingerprint information to RAM 302 using the not shown data bus.

At step 1403, CPU 301 performs the paper fingerprint information collation processing. This paper fingerprint information collation processing is as it is described using FIG. 9 in <Paper fingerprint information collation processing>.

At step 1404, CP 301 controls to display the result (valid or invalid) obtained in <Paper fingerprint information collation processing>on the display screen of operation part 12.

As described above, in the system which can guarantee the original document authenticity of the paper based on the asperity and the overlap of the random fiber on the paper surface, the image forming apparatus according to the embodiment of the present invention outputs the paper for output on which the image has been formed after confirming that the code information of the paper fingerprint document is valid, to the outside thereof. Thereby, an invalid document which becomes to be a collating error already at the time point of printing the paper fingerprint document and which has been overlooked in a conventional image forming apparatus is not printed and output. In the paper finger print document printing, it becomes possible to provide the image forming apparatus with high reliability.

The important thing in the embodiment according to the present invention is that the image forming apparatus which has performed this image formation detects the paper fingerprint deformation paper, before ejecting the paper on which the image formation of the code image data as well as the document data that is the object of the original document authenticity guarantee, has been completed. And in the case of the paper fingerprint deformation paper being detected, the countermeasure with respect to the paper of which the paper fingerprint has been deformed can be taken appropriately by performing post-processing (the process in which paper fingerprint deformation papers are accommodated in the cassette for paper fingerprint deformation papers and the re-printing is performed, according to the embodiment of the present invention) for the detection of the paper fingerprint deformation papers.

That is, in the embodiment of the present invention, when printing code image data and document data, the paper fingerprint information before starting of the printing and the paper fingerprint information after finishing of the printing are acquired from the papers on which the printing is performed, and are compared and the consistency examination is conducted. Therefore, even in the case of that the paper fingerprint of the paper which is going to be ejected has been deformed because of the heat at the time of fixing and contaminations at the time of printing, etc., the image forming device can detect this deformation having occurred and can perform the predetermined process before the paper ejection. The predetermined process like this is the above-mentioned post-processing. For example, like the embodiment according to the present invention, the post-processing is the process in which the detected paper fingerprint deformation paper is accommodated in the cassette for the paper fingerprint deformation papers and re-printing is performed, and the process in which the paper ejection into the tray only for paper fingerprint deformation paper is performed, etc. And as the predetermined process mentioned above, it may be preferable to print the image, on the paper fingerprint deformation paper, such as “invalid”, for example, indicating that the result of the collation between the paper fingerprint information before starting of the printing and the paper fingerprint information after finishing of the printing is not in agreement.

Thus, since the consistency examination can be automatically conducted within the same apparatus based on the embodiment according to the present invention, the number of processes required for the issuance of this document can be reduced when the original document authenticity is guaranteed and the document is output.

In the embodiment according to the present invention, paper fingerprint reading sensor 1005b for acquiring the paper fingerprint information after finishing of the printing has been disposed in the downstream side of fixing part 1003 from printing to the paper ejection. However, the paper fingerprint reading sensor 1005b may be provided between photoconductor drum 1009 and fixing part 1003. This is more desirable because the deformation of the paper fingerprint because of the heat in the fixing and because of the contaminations at the time of image formation can be detected by acquiring the paper fingerprint information after finishing of the printing in the above-mentioned downstream side of fixing part 1003, like the embodiment according to the present invention. However, paper fingerprint reading sensor 1005b for acquiring the paper fingerprint information after finishing of the printing may be disposed between photoconductor drum 1009 and fixing part 1003. Thus, by acquiring the paper fingerprint information after finishing of the printing in between photoconductor drum 1009 and fixing part 1003, the deformation of the paper fingerprint because of the contaminations at the time of the image formation can be detected.

### A Second Embodiment

According to a configuration of printer part 14 illustrated in FIG. 10 of the first embodiment mentioned above, paper fingerprint reading sensor 1005b disposed in paper carrying pass 1006 is located in the disposition (printing surface in FIG. 10) in which the reading of the surface in only one direction against the paper is possible. Therefore, in the case of that both-side printing is performed in the process of the job which comprises two or more pages, if the code information has been given to a first side, the paper fingerprint reading of the first side can not be performed when a second side is printed and ejected.

With this, the consistency confirmation of the code information based on the paper fiber image immediately before the paper ejection which will be the point of the present invention will not be able to be carried out.

In that case, an optical reflective pass is provided for paper fingerprint reading sensor 1005b which reads the paper fingerprint of the paper carried to paper ejection part 1014 or two reading sensors are made to be disposed on the upper side and the under side, etc., and thereby, a configuration in which the paper fingerprint of both-sides can be read may be preferable to be configured. With configuring such configuration, when ejecting paper, even if the code information is printed on either surface of a first side or a second side, the code information examination processing becomes possible, and the constraint against the surface on which the code information is to be given becomes unnecessary.

### A Third Embodiment

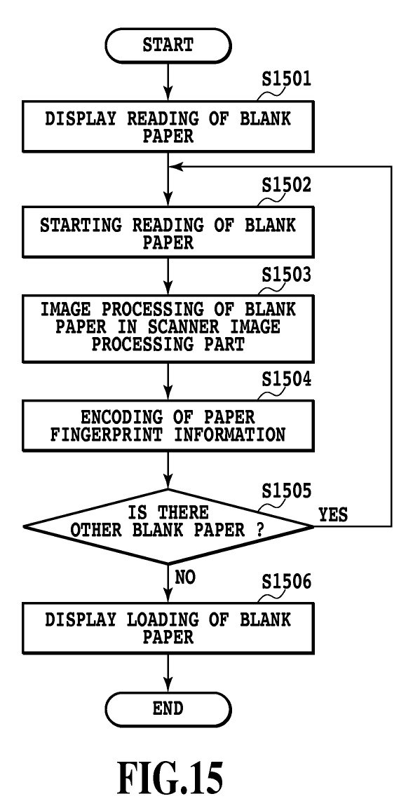

The first embodiment has the configuration by which the paper fingerprint information before starting of the printing is acquired from the paper fiber image of the paper read by paper fingerprint reading sensor 1005a when the paper used in the printing job passes paper carrying pass 1006. However, the paper fingerprint information may be read using scanner part 13. An embodiment in that case is described using a flowchart in FIG. 15.

When paper fingerprint paper register tab 710 is selected by the user and the paper fingerprint paper registration processing is started, CPU 301 controls to indicate intending “setting blank papers in original feeder 201” on the display screen of operation part 12 at step 1501.

At step 1502, CPU 301 reads the blank paper set in original feeder 201 by scanner part 13, and controls to send the paper fiber image (image data) of the read paper, as the image data, to scanner image processing part 312 via scanner I/F 311.

At step 1503, scanner image processing part 312 sets up a gain adjustment value smaller than the commonly used gain adjustment value in shading correction part 500. And scanner image processing part 312 outputs each luminance signal value acquired by applying the small gain adjustment value mentioned above to the image data acquired at step 1502 to paper fingerprint information acquisition part 507. Paper fingerprint information acquisition part 507 acquires the paper fingerprint information based on the output data. And the acquired paper fingerprint information is sent to RAM 302 using the not shown data bus. In addition, the paper fingerprint information acquired at step 1503 will be the paper fingerprint information which will become the base of the code image data generated at step 1504, and at the same time, will become the paper fingerprint information before starting of the printing.

At step 1504, CPU 301 encodes the paper fingerprint information acquired at step 1503 to generate the code image data, and sends to RAM 302 using the not shown data bus.

At step 1505, CPU 301 judges whether paper still remains in original feeder 201. This judgment can be performed based on the detection signal from the sensor (not shown) disposed in original feeder 201. In the case of that the blank paper still remains in original feeder 201, CPU 301 repeats the process from step 1502, reads the paper fingerprint information on all the blank paper and repeats the process for encoding thereof. At the time point of the paper on original feeder 201 being used up, CPU 301 makes a plurality of the paper and the code image data correspond to each other, and records them on HDD 304, with respect to a plurality of code image data stored in RAM 302.

At step 1506, CPU 301 controls to indicate the indication intending “loading paper cassette 203 with the paper of the read blank paper” on the display screen of operation part 12.

By the above paper fingerprint paper registration processing, the paper loaded in paper cassette 203 will be all in the state where the code image data has been generated. Therefore, in the description of the first embodiment, “paper fingerprint reading processing”, “paper fingerprint information extracting processing”, and “paper fingerprint encoding process” which has been performed in the process before the paper carrying become unnecessary, and the paper fingerprint information registration processing becomes to be able be carried out even without using paper fingerprint reading sensor 1005a.

In addition, in the paper fingerprint paper registration processing mentioned above, when loading the blank paper registered as the paper fingerprint paper in cassette 203, the pile order and the up and down relation of the paper needs to be in agreement with the conditions in which the paper has been read in original feeder 201. Therefore, a procedure by which the paper is made to be moved to paper cassette 203 from original feeder 201 may be displayed on the display screen of operation part 12 as a guidance which is easy to understand, etc.

And it is desirable that the blank paper registered as the paper fingerprint paper loaded in paper cassette 203 is administered, and it may be preferable for opening and closing of the paper cassette to be controlled by a usual key or a software control key, for example.

Although, in the above-mentioned description, it is described that the blank paper registered as the paper fingerprint paper is to be loaded in cassette 203, the blank paper may be loaded in paper cassette 205 and a not shown manual paper feed port. But in the case of that the feed port in which it is difficult to monitor extraction and insertion of the paper is utilized, it is desirable to adopt the process to prevent that the paper is operated by a third person by controlling so as to perform a work procedure which make the paper fingerprint information registration processing operate in succession.

### A Fourth Embodiment

The third embodiment mentioned above acquires the paper fingerprint information of the blank paper to generate the code image data by using original feeder 201 in the paper fingerprint paper registration processing. However, the paper fingerprint information, the code information, and the code image may be received from PC 40 or image forming apparatus 20 via LAN 50 or WAN. And the information provided by the paper manufacturing company etc. may be sufficient.

The image forming apparatus according to the embodiment of the present invention generates the code image to be synthesized into the printing image and performs the printing thereof, based on various information with respect to the paper fingerprint of the blank paper received from the outside. As a result, even if the image forming apparatus 30 does not have scanner part 13, and the image forming apparatus does not have paper fingerprint reading sensor 1005a for reading the paper fingerprint of the paper on paper carrying pass 1006, the paper fingerprint information registration processing will become possible.

That is, in an embodiment according to the present invention, when printing the document to be guaranteed in the originality authenticity and the code image data generated from the paper fingerprint of the paper for output on which this document is printed on the above-mentioned paper for output, what is necessary is for the image forming device just to maintain the above-mentioned code image data. Therefore, the image forming apparatus may read the image data from the above-mentioned paper for output by scanner part 13 and paper fingerprint reading sensor 1005a, etc., and may acquire the code image data based on the paper fingerprint acquired from this read image data. And the image forming apparatus may acquire the code image data by receiving the code image data from external devices such as PC and other image forming apparatus via LAN or WAN. Further, the image forming apparatus may acquire the above-mentioned code image data via a detachable media such as a magnetic disc and an optical disk.

In an embodiment according to the present invention, when performing the code information examination processing in the case of performing the printing mentioned above, what is necessary is for the image forming apparatus just to maintain the paper fingerprint information before starting of the printing and the paper fingerprint information after finishing of the printing. Therefore, like the code image data mentioned above, the image forming apparatus can acquire the paper fingerprint information before starting of the printing and the paper fingerprint information after finishing of the printing by scanner part 13, the paper fingerprint reading sensor, external devices, and the detachable media, etc.

### A Fifth Embodiment

In the first embodiment, in the case of “invalid” in the collation of the paper fingerprint information acquired by the paper carrying control post-processing in the paper fingerprint information registration processing, this paper has been accommodated in cassette 204 for paper fingerprint deformation papers by judging that the paper fingerprint deformation paper has been generated in the printing processes. This paper fingerprint deformation paper may be also ejected to finisher 15.

In that case, it is desirable to discriminate the printed matter judged to be “valid” in the collation of the paper fingerprint information and the printed matter judged to be “invalid”, and to perform the ejection thereof, by making paper ejection tray 207 of finisher 15 to be the paper ejection tray only for the paper fingerprint deformation papers, for example.

And in the case of the image forming apparatus connected with finisher 15 having a punching function and a cutting function, the printed matter judged to be “invalid” may be ejected to this finisher to be destroyed physically. Thus, by destroying physically the printed matter that is judged to be invalid, the effect for preventing the incorrect operation of the documents which cannot be judged visually to be “invalid” and of which the paper fingerprint information register has been performed is acquired.

Thus, in the embodiment and the first embodiment according to the present invention, as the post-processing for detection of the paper fingerprint deformation paper, the process is performed in which the paper ejection destination for the paper for output is changed depending on the printed matter judged to be valid or judged to be invalid.

### A Sixth Embodiment

In the first embodiment, in the case of “invalid” in the collation of the paper fingerprint information acquired by the paper carrying control post-processing in the paper fingerprint information registration processing, re-printing of this paper is performed judging that the paper fingerprint deformation paper has been generated in the printing processes. However, as for the process selected in the case of “invalid”, the optimal process in the predetermined processes may be dynamically applied corresponding to the generation states (the number of times, a rate of occurrence, etc.) of the paper fingerprint deformation paper.

As the predetermined processes, there are the processes such as shown in the following, for example.

A first process: re-printing of this paper.

A second process: alteration of control at the time of re-printing (fixing temperature and transportation speed).

A third process: process cancellation of the print job.

A fourth process: alteration of the paper used for the printing (alteration of the paper cassette).

Examples of the applications of these predetermined processes are described in the following.

(State A) the rate of occurrence of the paper fingerprint deformation paper is rare.

The process at the time of paper fingerprint deformation document occurrence:

→Re-print this paper (page) in which paper fingerprint deformation is generated.

(State B) the rate of occurrence of the paper fingerprint deformation paper is low.

The process at the time of paper fingerprint deformation document occurrence:

→Re-print this paper (page) on which paper fingerprint deformation is generated. In that case, the temperature of fixing part 1003 is lowered and sheet carrying speed is reduced.

(State C) the rate of occurrence of the paper fingerprint deformation paper is occasional.

The process at the time of paper fingerprint deformation document occurrence:

In the case of that the number of times of re-printing at the time of the paper fingerprint deformation paper occurrence has reached the prescribed number of times, the process of the print job is canceled.

(State D) the rate of occurrence of the paper fingerprint deformation paper is high only for the specific paper.

The process at the time of paper fingerprint deformation document occurrence:

→In the case of judging that the rate of occurrence of the paper fingerprint deformation paper is high with respect to the specific paper loaded in the paper cassette, the paper feeding is performed from a paper cassette other than the paper cassette.

Thus, in the embodiment according to the present invention, the image forming apparatus switches a plurality of post-processes for the detection of the paper fingerprint deformation paper to the process corresponding to the generation state mentioned above based on the generation state of the paper fingerprint deformation paper, or controls to combine the plurality of the post-processes. Therefore, in the embodiment according to the present invention, the process in the case of the paper fingerprint deformation paper being generated can be controlled optimally, and the effect of lowering the rate of the occurrence of the paper fingerprint deformation paper can be acquired.

In addition, as for the judgment of the states mentioned above, CPU 301 performs the judgment depending on the number of times in which the paper fingerprint deformation paper mentioned above has been generated within the prescribed period (for example, one month, etc.) for example, and thereby the judgment of the states mentioned above is realizable. In this case, the paper fingerprint deformation paper generation count is made to be stored in the memory of RAM 302, etc. and CPU 301 may just make the above-mentioned count increase whenever the paper fingerprint deformation paper is generated. In this way, the image forming apparatus can recognize the occurrence frequency of the paper fingerprint deformation paper, and can now switch to a suitable processing and then can combine the predetermined processes.

Thus, in the embodiment according to the present invention, the image forming apparatus switches a plurality of post-processes for the detection of the paper fingerprint deformation paper to the process corresponding to the generation state mentioned above based on the generation state of the paper fingerprint deformation paper, or controls to combine at least two processes from the plurality of the post-processes.

### A Seventh Embodiment

Image forming apparatus 10 used in the description of the first embodiment comprises three apparatuses of scanner part 13, printer part 14, and finisher 15 when classified largely, and is made to be the image forming apparatus of which the object is to be used in a common office. However, the present invention may be also what has been applied in the image forming apparatus which is capable of a high-speed image output utilized in a POD (Print on Demand) market and which operates with many sheet feeding devices and paper ejection devices connected.

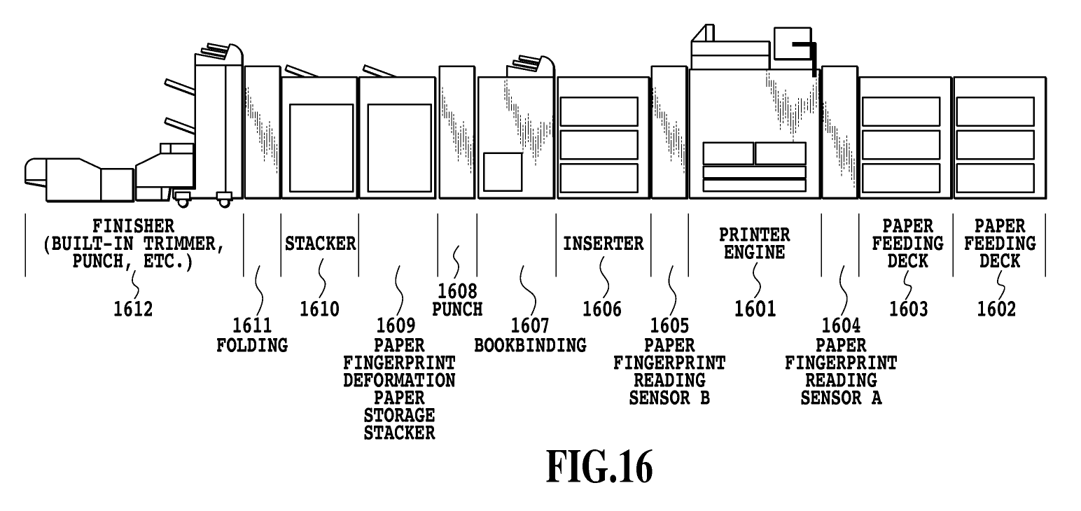

In the following, an example of a configuration of the image forming apparatus utilized in the POD market is given in FIG. 16, and is described.

Printer engine 1601 has a configuration excluding paper fingerprint reading sensors 1005a and 1005b and cassette 204 for paper fingerprint deformation papers from image forming apparatus 10 described in the first embodiment, and is an image forming apparatus having the same configuration and function as image forming apparatus 10 with respect to other portions.

Next, various accessory devices proper to POD markets-oriented image forming apparatus are described.

Paper feeding decks 1602 and 1603 which are paper feeding accessory devices adjoin the right-hand side of printer engine 1601 and are connected thereto. Paper feeding decks 1602 and 1603 are quipped with three steps of paper feeding decks, respectively. These paper feeding decks feed the paper located in the decks, and perform the operation of carrying the paper to paper fingerprint reading sensor A 1604 corresponding to the paper feeding instructions from printer engine 1601.

Next, paper fingerprint reading sensor A 1604 performs the operation sending the paper carried from the paper feeding deck to printer engine 1601. Paper fingerprint reading sensor A 1604 corresponds to paper fingerprint reading sensor 1005a of the first embodiment, and reads the paper fiber image of the paper to be carried by the control from CPU 301. In paper fingerprint reading sensor B 1605 on the left-hand side of printer engine 1601 of FIG. 16 where the left-hand side is located in the lower stream heading from the paper feeding to the paper ejection, the operation sending the paper carried from printer engine 1601 to inserter 1606 is performed. Paper fingerprint reading sensor B 1605 corresponds to paper fingerprint reading sensor 1005b of the first embodiment, and reads the paper fiber image of the paper carried by the control from CPU 301.

Inserter 1606 has entirely the same mechanical configuration as the paper feeding deck described previously. Since inserter 1606 is located in the downstream side of printer engine 1601, the image formation cannot be performed for the paper fed from here. In the case of inserting the paper having been printed already and the blank paper, etc., the paper is fed from this inserter 1606, and the operation by which the insert-paper is inserted between the papers carried from printer engine 1601 is performed.

Next, bookbinding 1607 having a bookbinding function is described. This bookbinding 1607 is a bookbinding machine which folds a book cover and starches up the back portion. The method of this bookbinding is fit for the full-scale bookbinding having much number of pages. The paper on which the image formation has been performed in printer engine 1601 passes along the through pass in inserter 1606, and is carried to bookbinding 1607. The body text (called inside paper) of the bookbinding is loaded temporarily in a stack tray in bookbinding 1607, and when all the inside papers are loaded, the bundled inside papers are starched and is carried to the confluent portion with the book cover. Finally the book cover of the twice size of the inside paper (accurately, size more than double) is carried from printer engine 1601 side or from inserter 1606 and the portion in which the inside paper has been starched is made to be pasted up on the center section of the book cover. Further, the book cover is folded to fold the inside papers. Further, depending on the setting, cutting of one direction or three directions is performed to complete the bookbinding. Finally, the book is ejected into the paper ejection tray in bookbinding 1607.

Next, punch 1608 can punch the punch holes of two holes, three holes, four holes, or 30 holes. Next, numeral 1609 is a paper fingerprint deformation paper storage stacker. It is possible to stack the papers of 5000 sheets, for example. This paper fingerprint deformation paper storage stacker 1609 is used for accommodating the fingerprint deformation paper in the case of becoming “invalid” in collating the paper fingerprint information after finishing of the printing acquired in paper carrying control post-processing in paper fingerprint information registration processing.

Next, numeral 1610 is the stacker. It is possible to stack the papers of 5000 sheets, for example. The stacker has a sample tray in this stacker upper part. This tray is used as the tray which is utilized in the case of that a proof output for image confirmation is performed while outputting operation of the body text is performed. When performing output of extensive number of sheets or extensive number of copies, the image of the page having been specified in advance apart from the output of the body text is output to the sample tray when the user gives instructions from the operation panel.

Next, folding 1611 has the function to fold the paper which performs 2 folding, 3 folding, and gatefold folding, etc. with respect to the carried papers. The folded papers are carried further to the downstream paper ejection device. Finally, numeral 1612 is the finisher. Numeral 1612 has a shift sorting function and a staple sorting function such as one-part binding, two-part binding and inside binding. Numeral 1612 has two or more steps of paper ejection trays, and it is also possible to set up as the tray for exclusive use for every type of jobs such as a copy function and print function, and a facsimile receiving and printing function. This numeral 1612 has a configuration which can be connected with inserter 1606, a saddle bookbinding machine and a trimmer, etc. as options. Therefore, it is possible to insert the insert-paper by inserter 1606 at the last stage, and an inside-bound bookbinding having a finish like the bookbinding of a weekly magazine folded in two-folding can be performed by stapling the back by the saddle bookbinding machine. And it is also possible to make the finish good by cutting one side of the paper which has been bound by the trimmer.

As mentioned above, using the image forming apparatus composed for POD markets, the process of paper fingerprint reading sensor 1005a in the description for the first embodiment is transposed to paper fingerprint reading sensor A 1604. And the process of paper fingerprint reading sensor 1005b is transposed to paper fingerprint reading sensor B 1605. And the configuration in which the process of cassette 204 for paper fingerprint deformation papers is transposed to paper fingerprint deformation storage stacker 1609 and is performed therein is made to be configured, and the configuration in which paper fingerprint reading sensors 1005a and 1005b and cassette 204 for paper fingerprint deformation papers are made to be installed in the outside of image forming apparatus 10 may be possible.

### Other Embodiments

The present invention is able to be applied not only to the system which comprises a plurality of instruments (for example, a computer, an interface instrument, a reader, a printer, etc.), but also to the apparatus (a composite machine, a printer, facsimile apparatus, etc.) which comprises one instrument.

The method of processing for making the program which makes the configuration of the embodiment mentioned above operate, be stored in a storage medium so as to realize the function of the embodiment mentioned above, and for reading the program stored in this storage medium as the code to execute on the computer, is also included in the category of the above-mentioned embodiment. That is, the storage medium which is computer-readable is also included in the range of the embodiment. And not only the storage medium as a matter of course in which the above-mentioned computer program has been stored, but also the computer program itself are included in the above-mentioned embodiment.

As such a storage medium, a floppy (registered trademark) disc, a hard disk, an optical disk, a magneto-optic disk, CD-ROM, a magnetic tape, a nonvolatile memory card, and ROM, for example, can be used.

Not only what performs the process using the program unit stored in the above-mentioned storage medium, but also what operates on OS in collaboration with the function of other software and an expansion board, and performs the operation of the above-mentioned embodiment, are included in the category of the embodiment mentioned above.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-039269, filed Feb. 20, 2008, which is hereby incorporated by reference herein in its entirety.

What is claimed is:

1. An image forming apparatus comprising:
a component for printing a code image data generated based on a paper fingerprint data of a paper for output on which a document image is to be printed;
a component for acquiring the paper fingerprint data before starting of the printing;
a component for acquiring the paper fingerprint data after finishing of the printing;
a component for collating the paper fingerprint data before starting of the printing and the paper fingerprint data after finishing of the printing; and
a component for judging, based on the collated result, whether the paper fingerprint before starting of the printing is deformed by the printing.

2. The image forming apparatus according to claim 1, further comprising:
a component for performing a predetermined process when detecting the paper with the paper fingerprint thereof deformed, in the case of being judged by the component for judging that the paper for output is the paper with the paper fingerprint thereof deformed.

3. The image forming apparatus according to claim 2, wherein the predetermined process has a plurality of processes,
wherein the component for performing the predetermined process switches the predetermined process to another process or performs the process including combination of at least two processes of the predetermined process, based on generation state of the paper with the paper fingerprint thereof deformed.

4. The image forming apparatus according to claim 2, wherein the predetermined process is a process to change a paper ejection destination of the paper for output in the case of being judged that the paper for output is the paper with the paper fingerprint thereof deformed and in the case of being judged that the paper for output is not the paper with the paper fingerprint thereof deformed.

5. The image forming apparatus according to claim 1, further comprising:
a component for reading an image data of the paper for output;
a component for extracting the paper fingerprint data from the read image data; and
a component for generating the code image data based on the extracted paper fingerprint data.

6. The image forming apparatus according to claim 1, further comprising:
a component for acquiring the code image data from an external device or a detachable media connected to the image forming apparatus.

7. The image forming apparatus according to claim 1, wherein the component for acquiring the paper fingerprint data before starting of the printing comprises:
a component for reading the image data of the paper for output before starting of the printing; and
a component for extracting the paper fingerprint data before starting of the printing from the read image data.

8. The image forming apparatus according to claim 1, wherein the component for acquiring the paper fingerprint data before starting of the printing acquires the paper fingerprint data before starting of the printing from the external device or the detachable media connected to the image forming apparatus.

9. The image forming apparatus according to claim 1, wherein the component for acquiring the paper fingerprint data after finishing of the printing comprises:
a component for reading the image data of the paper for output after finishing of the printing; and
a component for extracting the paper fingerprint data after finishing of the printing from the read image data.

10. The image forming apparatus according to claim 1, wherein the component for acquiring the paper fingerprint data after finishing of the printing acquires the paper fingerprint data after finishing of the printing from the external device or the detachable media connected to the image forming apparatus.

11. An image forming method, comprising the steps of:
printing a code image data generated based on a paper fingerprint data of a paper for output on which a document image is to be printed;
collating the paper fingerprint data before starting of the printing, and the paper fingerprint data after finishing of the printing; and
judging whether the paper fingerprint before starting of the printing is deformed by the printing, based on the collated result,
wherein the paper fingerprint data before starting of the printing and the paper fingerprint data after finishing of the printing are acquired before the step of collating.

12. The image forming method according to claim 11, further comprising the step of:
performing a predetermined process when detecting the paper with the paper fingerprint thereof deformed, in the case of being judged by the step for judging that the paper for output is the paper with the paper fingerprint thereof deformed.

13. The image forming method according to claim 12, wherein the predetermined process has a plurality of processes,
wherein the step for performing the predetermined process switches the predetermined process to another process, or performs the process including combination of at least two processes of the predetermined process, based on generation state of the paper with the paper fingerprint thereof deformed.

14. The image forming method according to claim 12, wherein the predetermined process is a process to change a paper ejection destination of the paper for output in the case of being judged that the paper for output is the paper with the paper fingerprint thereof deformed and in the case of being judged that the paper for output is not the paper with the paper fingerprint thereof deformed.

15. The image forming method according to claim 11, further comprising the steps of:
reading an image data of the paper for output;
extracting the paper fingerprint data from the read image data; and
generating the code image data based on the extracted paper fingerprint data.

16. The image forming method according to claim 11, further comprising the step of:
acquiring the code image data from an external device or a detachable media connected to the image forming apparatus.

17. The image forming method according to claim 11, further comprising the steps of:
reading the image data of the paper for output before starting of the printing; and
extracting the paper fingerprint data before starting of the printing from the read image data.

18. The image forming method according to claim 11, further comprising the step of:
acquiring the paper fingerprint data before starting of the printing from the external device or the detachable media connected to the image forming apparatus.

19. The image forming method according to claim 11, further comprising the steps of:
reading the image data of the paper for output after finishing of the printing; and
extracting the paper fingerprint data after finishing of the printing from the read image data.

20. The image forming method according to claim 11, wherein the paper fingerprint data after finishing of the printing is acquired from the external device or the detachable media connected to the image forming apparatus.

21. A computer-readable recording medium having computer-executable instructions for performing a method, the method comprising the steps of:
printing a code image data generated based on a paper fingerprint data of a paper for output on which a document is to be printed;
collating the paper fingerprint data before starting of the printing and the paper fingerprint data after finishing of the printing; and
judging whether the paper for output being the paper with the paper fingerprint before starting of the printing is deformed bye the printing, based on the collated result,
wherein the paper fingerprint data before starting of the printing and the paper fingerprint data after finishing of the printing are acquired before the step for collating.
